(19) United States
(12) Patent Application Publication
(10) Pub. No.: US 2025/0367971 A1
(43) Pub. Date: Dec. 4, 2025

(54) WHEELED CHILDCARE DEVICE

(71) Applicant: GRACO CHILDREN'S PRODUCTS INC., Atlanta, GA (US)

(72) Inventors: Tomoyuki HONDA, Tokyo (JP); Hitoshi YABUUCHI, Tokyo (JP); Shozo MATSUSHITA, Tokyo (JP)

(73) Assignee: GRACO CHILDREN'S PRODUCTS INC., Atlanta, GA (US)

(21) Appl. No.: 19/218,120

(22) Filed: May 23, 2025

(30) Foreign Application Priority Data
May 28, 2024 (JP) 2024-086385
May 28, 2024 (JP) 2024-086386
May 28, 2024 (JP) 2024-086387
Jun. 19, 2024 (JP) 2024-098647
Sep. 2, 2024 (JP) 2024-150580
Sep. 2, 2024 (JP) 2024-150581

(51) Int. Cl. B60B 33/02; B60B 33/00; B62B 7/04

(52) U.S. Cl. CPC B60B 33/026; B62B 7/042; B60B 33/0057; B62B 2301/046

(57) ABSTRACT

A wheeled childcare device includes: a body frame; a caster mechanism including a caster holding member and a caster pivot member and configured to allow a front wheel or a rear wheel to swivel; a caster lock member provided in the caster mechanism and configured to assume a lock position and an unlock position; a displacement member connected to the caster lock member via a connecting member and configured to be displaced between a first position corresponding to the lock position of the caster lock member and a second position corresponding to the unlock position of the caster lock member, according to switching of the position of a push bar; and an operation mechanism provided on the push bar and configured to operate the displacement member to switch the displacement member from the first position to the second position.

### CROSS-REFERENCE TO RELATED APPLICATIONS

This application claims priority to the following JP Patent Application Nos.: 2024-086387 filed May 28, 2024; 2024-086386 filed May 28, 2024; 2024-086385 filed May 28, 2024; 2024-098647 filed Jun. 19, 2024; 2024-150580 filed Sep. 2, 2024; and 2024-150581 filed Sep. 2, 2024, the entire contents of which are incorporated herein by reference.

### BACKGROUND

The present invention relates to wheeled childcare devices.

Strollers are conventionally known in which a push bar is slidable in the front-rear direction of the stroller to allow switching between front-facing (infant/toddler facing forward) and rear-facing (infant/toddler facing rearward) modes. Such a stroller desirably has caster wheels as its front and rear wheels so that the front wheels in the direction of travel can be unlocked (allowed to swivel) and the rear wheels in the direction of travel can be locked (not allowed to swivel).

It is cumbersome for a stroller operator to manually operate the caster locks on each wheel when locking desired caster wheels. An automatic four-wheel mechanism is known as a solution to this. With an automatic four-wheel mechanism, a stroller operator does not have to manually unlock or lock the caster wheels. The automatic four-wheel mechanism automatically unlocks the front caster wheels in the direction of travel and locks the rear caster wheels in the direction of travel according to the position of the push bar in the front-rear direction.

As such an automatic four-wheel mechanism for strollers, various structures are known, such as Japanese Unexamined Patent Application Publication Nos. 2008-254688, 2013-6553, and 2021-014921.

Japanese Unexamined Patent Application Publication Nos. 2008-254688 and 2013-6553 each disclose a stroller with a push bar that is switchable between rear-facing and front-facing positions. When the push bar is swung forward, it comes into contact with a lock switching member and pushes the lock switching member downward. This causes the lock switching member to slide downward, thereby locking the caster wheels on the front legs to prohibit swiveling and unlocking the caster wheels on the rear legs to allow swiveling.

Japanese Unexamined Patent Application Publication No. 2021-014921 discloses that, when the push bar is in the rear-facing position, caster wheels are unlocked by operating an operation part on a push bar.

### SUMMARY

In the strollers disclosed in Japanese Unexamined Patent Application Publication Nos. 2008-254688 and 2013-6553, the caster wheels can be unlocked or locked by switching the position of the push bar. In the stroller disclosed in Japanese Unexamined Patent Application Publication No. 2021-014921, the caster wheels can be intentionally unlocked by operating the operation part on the push bar, rather than by switching the position of the push bar. In these strollers, however, the structures for locking and unlocking the caster wheels require many parts and are complex.

The present invention has been made to address such an issue, and its object is to provide a wheeled childcare device with a simple structure.

In order to achieve this object, a wheeled childcare device according to one aspect of the present invention includes a body frame, a caster mechanism, a caster lock member, a displacement member, and an operation mechanism. The body frame includes a front leg, a rear leg, and a push bar that is switchable between a front-facing position and a rear-facing position. The caster mechanism includes a caster holding member and a caster pivot member, and is configured to allow a front wheel or a rear wheel to swivel. The caster holding member is provided at a lower end of the front leg or the rear leg. The caster pivot member is held by the caster holding member so as to be pivotable around a pivot axis extending in an up-down direction. The caster pivot member supports the front wheel or the rear wheel via a shaft. The caster lock member is provided in the caster mechanism, and is configured to restrict pivoting of the caster pivot member when the caster lock member is in the caster lock member is in a lock position and to permit the pivoting of the caster pivot member when the caster lock member is in an unlock position. The displacement member is provided on the body frame and is connected to the caster lock member via a connecting member. The displacement member is configured to be displaced between a first position and a second position according to switching of the position of the push bar. The first position corresponds to the lock position of the caster lock member, and the second position corresponds to the unlock position of the caster lock member. The operation mechanism is provided on the push bar and is configured to operate the displacement member to switch the displacement member from the first position to the second position.

Preferably, the wheeled childcare device further includes a first biasing member configured to bias the displacement member toward the second position.

Preferably, the operation mechanism includes an operation member and a drive member. The drive member is connected to the operation member and is configured to be switched between a first state and a second state by an operating force of the operation member. The drive member is configured to move the displacement member to the first position when the drive member is in the first state. The drive member is configured to move the displacement member to the second position when the drive member is in the second state.

Preferably, the operation mechanism includes an operation member and a drive member. The drive member is connected to the operation member and is configured to be switched between a first state and a second state by an operating force of the operation member. The drive member is configured to counteract a biasing force of the first biasing member on the displacement member when the drive member is in the first state. The drive member is configured to allow the biasing force of the first biasing member on the displacement member to act effectively, when the drive member is in the second state.

Preferably, the operation mechanism further includes a second biasing member configured to bias the drive member toward the first state. A biasing force of the second biasing member is greater than the biasing force of the first biasing member.

Preferably, the wheeled childcare device further includes a third biasing member configured to bias the caster lock member toward the lock position. A biasing force of the third biasing member is smaller than the biasing force of the first biasing member.

Preferably, the caster mechanism includes a front-wheel caster mechanism and a rear-wheel caster mechanism. The front-wheel caster mechanism includes a front-wheel caster holding member and a front-wheel caster pivot member and is configured to allow the front wheel to swivel. The front-wheel caster holding member is provided at the lower end of the front leg. The front-wheel caster pivot member is held by the front-wheel caster holding member so as to be pivotable around a pivot axis extending in the up-down direction. The front-wheel caster pivot member supports the front wheel via the shaft. The rear-wheel caster mechanism includes a rear-wheel caster holding member and a rear-wheel caster pivot member and is configured to allow the rear wheel to swivel. The rear-wheel caster holding member is provided at the lower end of the rear leg. The rear-wheel caster pivot member is held by the rear-wheel caster holding member so as to be pivotable around a pivot axis extending in the up-down direction. The rear-wheel caster pivot member supports the rear wheel via the shaft. The caster lock member includes a front-wheel caster lock member and a rear-wheel caster lock member. The front-wheel caster lock member is provided in the front-wheel caster mechanism and is configured to restrict pivoting of the front-wheel caster pivot member when the front-wheel caster lock member is in the lock position and to permit the pivoting of the front-wheel caster pivot member when the front-wheel caster lock member is in the unlock position. The rear-wheel caster lock member is provided in the rear-wheel caster mechanism and is configured to restrict pivoting of the rear-wheel caster pivot member when the rear-wheel caster lock member is in the lock position and to permit the pivoting of the rear-wheel caster pivot member when the rear-wheel caster lock member is in the unlock position.

Preferably, the displacement member includes a front-wheel-side displacement member and a rear-wheel-side displacement member. The front-wheel-side displacement member is provided on the front leg and is connected to the front-wheel caster lock member. The front-wheel-side displacement member is configured to be displaced between a first position and a second position as the front-wheel-side displacement member is pushed by the push bar according to the switching of the position of the push bar. The first position corresponds to the lock position of the front-wheel caster lock member, and the second position corresponds to the unlock position of the front-wheel caster lock member. The rear-wheel-side displacement member is provided on the rear leg and is connected to the rear-wheel caster lock member. The rear-wheel-side displacement member is configured to be displaced between a first position and a second position as the rear-wheel-side displacement member is pushed by the push bar according to the switching of the position of the push bar. The first position corresponds to the lock position of the rear-wheel caster lock member, and the second position corresponds to the unlock position of the rear-wheel caster lock member.

Preferably, the displacement member is movable up and down along the body frame.

Preferably, the displacement member is pivotable relative to the body frame.

A wheeled childcare device according to another aspect of the present invention includes a body frame, a caster mechanism, a caster lock member, a displacement member, a first biasing member, and a drive member. The body frame includes a front leg, a rear leg, and a push bar. The caster mechanism includes a caster holding member and a caster pivot member and is configured to allow a front wheel or a rear wheel to swivel. The caster holding member is provided at a lower end of the front leg or the rear leg. The caster pivot member is held by the caster holding member so as to be pivotable around a pivot axis extending in an up-down direction. The caster pivot member supports the front wheel or the rear wheel via a shaft. The caster lock member is provided in the caster mechanism and is configured to restrict pivoting of the caster pivot member when the caster lock member is in a lock position and to permit the pivoting of the caster pivot member when the caster lock member is in an unlock position. The displacement member is provided on the body frame and is connected to the caster lock member via a connecting member. The displacement member is configured to be displaced between a first position and a second position. The first position corresponds to the lock position of the caster lock member, and the second position corresponds to the unlock position of the caster lock member. The first biasing member is configured to bias the displacement member toward the second position. The drive member is provided on the push bar and is configured to be switched between a first state and a second state. The first state corresponds to the displacement member in the first position, and the second state corresponds to the displacement member in the second position.

Preferably, the wheeled childcare device further includes an operation mechanism provided on the push bar and configured to operate the displacement member to switch the displacement member from the first position to the second position. The operation member includes an operation member and the drive member. The drive member is connected to the operation member and is configured to be switched between the first state and the second state by an operating force of the operation member. The drive member is configured to counteract a biasing force of the first biasing member on the displacement member when the drive member is in the first state. The drive member is configured to allow the biasing force of the first biasing member on the displacement member to act effectively, when the drive member is in the second state.

Preferably, the operation mechanism further includes a second biasing member configured to bias the drive member toward the first state. A biasing force of the second biasing member is greater than the biasing force of the first biasing member.

Preferably, the wheeled childcare device further includes a third biasing member configured to bias the caster lock member toward the lock position. A biasing force of the third biasing member is smaller than the biasing force of the first biasing member.

A wheeled childcare device according to still another aspect of the present invention includes a body frame, a front-wheel caster mechanism, a rear-wheel caster mechanism, a front-wheel caster lock member, a rear-wheel caster lock member, a front-wheel-side displacement member, a rear-wheel-side displacement member, and an operation member. The body frame includes a front leg, a rear leg, and a push bar that is switchable between a front-facing position and a rear-facing position. The front-wheel caster mechanism includes a front-wheel caster holding member and a front-wheel caster pivot member and is configured to allow a front wheel to swivel. The front-wheel caster holding member is provided at a lower end of the front leg. The front-wheel caster pivot member is held by the front-wheel caster holding member so as to be pivotable around a pivot axis extending in an up-down direction. The front-wheel caster pivot member supports the front wheel via a shaft. The rear-wheel caster mechanism includes a rear-wheel caster holding member and a rear-wheel caster pivot member and is configured to allow a rear wheel to swivel. The rear-wheel caster holding member is provided at a lower end of the rear leg. The rear-wheel caster pivot member is held by the rear-wheel caster holding member so as to be pivotable around a pivot axis extending in the up-down direction. The rear-wheel caster pivot member supports the rear wheel via a shaft. The front-wheel caster lock member is provided in the front-wheel caster mechanism and is configured to restrict pivoting of the front-wheel caster pivot member when the front-wheel caster lock member is in a lock position and to permit the pivoting of the front-wheel caster pivot member when the front-wheel caster lock member is in an unlock position. The rear-wheel caster lock member is provided in the rear-wheel caster mechanism and is configured to restrict pivoting of the rear-wheel caster pivot member when the rear-wheel caster lock member is in a lock position and to permit the pivoting of the rear-wheel caster pivot member when the rear-wheel caster lock member is in an unlock position. The front-wheel-side displacement member is provided on the body frame and is connected to the front-wheel caster lock member via a connecting member. The front-wheel-side displacement member is configured to be displaced between a first position and a second position. The first position corresponds to the lock position of the front-wheel caster lock member, and the second position corresponds to the unlock position of the front-wheel caster lock member. The rear-wheel-side displacement member is provided on the body frame so as to be separated from the front-wheel-side displacement member. The rear-wheel-side displacement member is connected to the rear-wheel caster lock member via a connecting member and configured to be displaced between a first position and a second position. The first position corresponds to the lock position of the rear-wheel caster lock member, and the second position corresponds to the unlock position of the rear-wheel caster lock member. The operation mechanism is provided on the push bar and is configured to operate the front-wheel caster lock member and the rear-wheel caster lock member to switch the front-wheel caster lock member and the rear-wheel caster lock member from the lock position to the unlock position.

Preferably, the wheeled childcare device further includes: a first front-wheel-side biasing member configured to bias the front-wheel-side displacement member toward the second position; and a first rear-wheel-side biasing member configured to bias the rear-wheel-side displacement member toward the second position.

Preferably, the operation mechanism is configured to operate the front-wheel-side displacement member and the rear-wheel-side displacement member to switch the front-wheel-side displacement member and the rear-wheel-side displacement member from the first position to the second position. The operation mechanism includes an operation member and a drive member. The drive member is connected to the operation member and is configured to be switched between a first state and a second state by an operating force of the operation member. The drive member is configured to move the front-wheel-side displacement member or the rear-wheel-side displacement member to the first position when the drive member is in the first state. The drive member is configured to move the front-wheel-side displacement member or the rear-wheel-side displacement member to the second position when the drive member is in the second state.

Preferably, the operation mechanism further includes a second biasing member configured to bias the drive member toward the first state. A biasing force of the second biasing member is greater than a biasing force of the first front-wheel-side biasing member and a biasing force of the first rear-wheel-side biasing member.

Preferably, the wheeled childcare device further include: a third front-wheel-side biasing member configured to bias the front-wheel caster lock member toward the lock position; and a third rear-wheel-side biasing member configured to bias the rear-wheel caster lock member toward the lock position. A biasing force of the third front-wheel-side biasing member is smaller than a biasing force of the first front-wheel-side biasing member. A biasing force of the third rear-wheel-side biasing member is smaller than a biasing force of the first rear-wheel-side biasing member.

The present invention thus provides a wheeled childcare device with a simple structure.

### BRIEF DESCRIPTION OF THE DRAWINGS

FIG. 1 shows side views of a stroller according to a first embodiment of the present invention, where FIG. 1(A) shows a push bar in a front-facing position, and FIG. 1(B) shows the push bar in a rear-facing position.

FIG. 2 schematically shows the internal structure of the stroller of the first embodiment, illustrating a state in which an operation mechanism is not operated in a front-facing mode.

FIG. 3 schematically shows the internal structure of the stroller of the first embodiment, illustrating a state in which the operation mechanism is operated in the front-facing mode.

FIG. 4 schematically shows the internal structure of the stroller of the first embodiment, illustrating a state in which the operation mechanism is not operated in a rear-facing mode.

FIG. 5 schematically shows the internal structure of the stroller of the first embodiment, illustrating a state in which the operation mechanism is operated in the rear-facing mode.

FIG. 6 shows side views of a modification of the first embodiment, where FIG. 6(A) shows the front-facing mode and FIG. 6(B) shows the rear-facing mode.

FIG. 7 shows perspective views illustrating part of the stroller in the front-facing mode, where FIG. 7(A) shows a state in which the operation mechanism is not operated, and FIG. 7(B) shows a state in which the operation mechanism is operated.

FIG. 8 shows perspective views illustrating part of the stroller in the rear-facing mode, where FIG. 8(A) shows a state in which the operation mechanism is not operated, and FIG. 8(B) shows a state in which the operation mechanism is operated.

FIG. 9 shows a modification of a caster lock member, where FIG. 9(A) shows an unlocked state, and FIG. 9(B) shows a locked state.

FIG. 10 schematically shows the internal structure of a stroller according to a second embodiment of the present invention, illustrating a state in which an operation mechanism is not operated in the front-facing mode.

FIG. 11 schematically shows the internal structure of the stroller of the second embodiment, illustrating a state in which the operation mechanism is operated in the front-facing mode.

FIG. 12 schematically shows the internal structure of the stroller of the second embodiment in the front-facing mode, where FIG. 12(A) shows a state in which the operation mechanism is not operated, and FIG. 12(B) shows a state in which the operation mechanism is operated.

FIG. 13 shows the internal structure of a front-wheel-side displacement member.

FIG. 14 schematically shows the internal structure of a stroller according to a third embodiment of the present invention in the rear-facing mode, where FIG. 14(A) shows a state in which an operation mechanism is not operated, and FIG. 14(B) shows a state in which the operation mechanism is operated.

FIG. 15 shows views corresponding to FIG. 13, illustrating movement of a front-wheel-side displacement member, where FIG. 15(A) shows a state in which the operation mechanism is not operated, and FIG. 15(B) shows a state in which the operation mechanism is operated.

FIG. 16 schematically shows the internal structure of a stroller according to a fourth embodiment of the present invention in the front-facing mode, where FIG. 16(A) shows a state in which an operation mechanism is not operated, and FIG. 16(B) shows a state in which the operation mechanism is operated.

FIG. 17 schematically shows the internal structure of the stroller of the fourth embodiment in the rear-facing mode, where FIG. 17(A) shows a state in which the operation mechanism is not operated, and FIG. 17(B) shows a state in which the operation mechanism is operated.

FIG. 18 schematically shows the internal structure of a stroller according to a fifth embodiment of the present invention in the front-facing mode, where FIG. 18(A) shows a state in which an operation mechanism is not operated, and FIG. 18(B) shows a state in which the operation mechanism is operated.

FIG. 19 schematically shows the internal structure of the stroller of the fifth embodiment in the rear-facing mode, showing a state in which the operation mechanism is not operated.

FIG. 20 shows views corresponding to FIG. 19, illustrating movement of an inter-wheel displacement member, where FIG. 20(A) shows a state in which the operation mechanism is not operated, and FIG. 20(B) shows a state in which the operation mechanism is operated.

### DETAILED DESCRIPTION

Embodiments of the present invention will be described in detail with reference to the drawings. The same or corresponding portions are denoted by the same signs throughout the drawings, and description thereof will not be repeated.

### First Embodiment

### Configurations

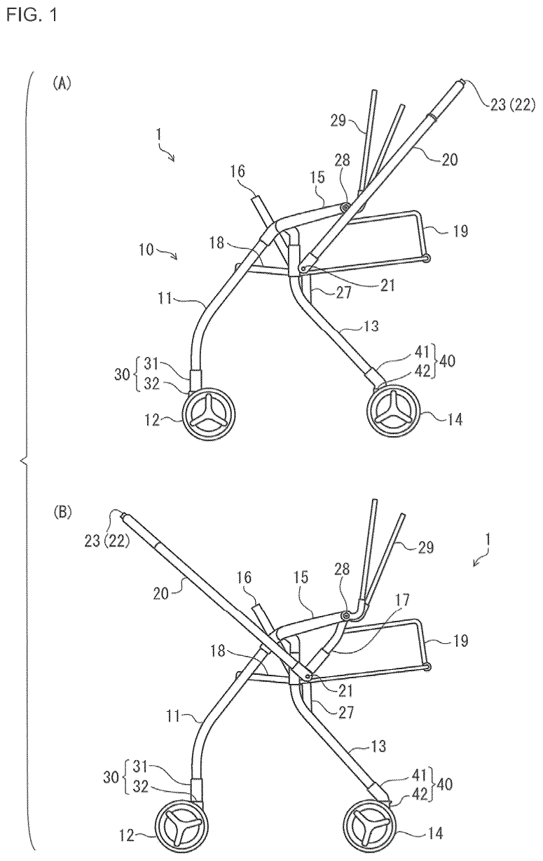

An overview of a stroller 1 according to a first embodiment will be described with reference to FIGS. 1(A) and 1(B). FIG. 1(A) shows a push bar in a front-facing position. FIG. 1(B) shows the push bar in a rear-facing position. To facilitate understanding of the invention, these figures mainly show a body frame of a reversible stroller, and do not show components such as an infant/toddler seat. In the following description, the front-rear direction refers to the front-rear direction of the stroller, and the left-right direction refers to the left-right direction when viewed from the front of the stroller.

The stroller 1 of the present embodiment includes, as a body frame 10, a pair of front legs 11, a pair of rear legs 13, an armrest 15, an armrest support member 17, a seat support member 18, a backrest support member 19, and a push bar 20. The components of the body frame 10 other than the seat support member 18, the backrest support member 19, and the push bar 20 are provided in pairs on the right and left sides such that the components of each pair are separated from each other in the width direction (stroller width direction).

A front-wheel caster mechanism 30 is provided at the lower end of each front leg 11 extending in the up-down direction. A front wheel 12 is provided at the lower end of each front leg 11 with the front-wheel caster mechanism 30 interposed therebetween. A rear-wheel caster mechanism 40 is provided at the lower end of each rear leg 13 located behind each front leg 11 and extending in the up-down direction. A rear wheel 14 is provided at the lower end of each rear leg 11 with the rear-wheel caster mechanism 40 interposed therebetween. The front-wheel caster mechanism 30 and the rear-wheel caster mechanism 40 will be described later.

The upper end of the front leg 11 is pivotally connected to the front end of the armrest 15 extending in the front-rear direction of the stroller 1. The upper end of the rear leg 13 is pivotally connected to a front-end portion of the armrest 15 at a position behind the upper end of the front leg 11. As shown in FIG. 1(B), the rear end of the armrest 15 is pivotally connected via a pivot shaft 28 to the upper end of the armrest support member 17 extending in the up-down direction. Specifically, the rear end of the armrest 15 and the upper end of the armrest support member 17 are also connected to canopy ribs 29 via the pivot shaft 28.

The seat support member 18 is disposed below the armrest 15. The front end of the seat support member 18 is connected to the middle portions of the front legs 11. The rear end of the seat support member 18 is pivotally connected to the lower end of the push bar 20, the upper ends of reversal brackets 27, and the lower ends of the armrest support members 17 via swing shafts 21.

The rear end of the seat support member 18 is pivotally connected to the lower end of the backrest support member 19 at a position different from the swing shafts 21. The seat support member 18 supports an infant/toddler seating portion from below, and the backrest support member 19 supports an infant/toddler backrest portion from below. Although not shown in the figures, a hammock is suspended across the seat support member 18 and the backrest support member 19, and a cushion is attached to the hammock. A seat surface forming a seat portion is thus formed over the seat support member 18, and the seat support member 18 supports the seat surface from below.

The push bar 20 has, for example, an inverted U-shape. The push bar 20 is swingable in the front-rear direction relative to the body frame 10 via the swing shafts 21 and is switchable between the front-facing position (FIG. 1(A)) and the rear-facing position (FIG. 1(B)). Specifically, the lower end of the push bar 20 is pivotally connected to the lower ends of the armrest support members 17 described later via the swing shafts 21. Each swing shaft 21 is disposed adjacent to a corresponding rear leg 13. An operation mechanism 22 is provided at the upper end of the push bar 20. The operation mechanism 22 will also be described later.

As shown in FIG. 1(B), the armrest support member 17 is a member extending in the up-down direction. The upper end of the armrest support member 17 is pivotally connected to the rear end of the armrest 15 and the two canopy ribs 29 via the pivot shaft 28. The lower end of the armrest support member 17 is pivotally connected to the lower end of the push bar 20, the upper end of the reversal bracket 27, and the rear end of the seat support member 18 via the swing shaft 21. Although not shown in the figures, a plurality of auxiliary canopy ribs is arranged between the canopy ribs 29, and a canopy fabric is stretched between the canopy ribs 29.

The lower end of the armrest support member 17 is switchable between a position where the armrest support member 17 is locked relative to the rear leg 13 and a position where the armrest support member 17 is unlocked from the rear leg 13. The position where the armrest support member 17 is locked relative to the rear leg 13 corresponds to a traveling state shown in FIGS. 1(A) and 1(B). This position is the position where the lower end of the armrest support member 17 and the middle portion of the rear leg 13 are in contact with each other.

The position where the armrest support member 17 is unlocked from the rear leg 13 corresponds to a folded state, not shown. This position is the position where the lower end of the armrest support member 17 and the lower end of the rear leg 13 are in contact with each other. Specifically, a lock portion (not shown) that can lock the armrest support member 17 relative to the rear leg 13 is provided at the lower end of the armrest support member 17. The armrest support member 17 can be unlocked from the rear leg 13 by unlocking the lock portion. This configuration allows the stroller 1 to be folded. The lock portion may be provided at the upper end of the reversal bracket 27.

In the stroller 1 described above, both the front wheels 12 and the rear wheels 14 are caster wheels. In a normal state where the operation mechanism 22 is not operated, the front wheels in the direction of travel are unlocked (allowed to swivel), while the rear wheels in the direction of travel are locked (not allowed to swivel). In an operating state in which the operation mechanism 22 is operated, all of the wheels 12, 14 are unlocked (allowed to swivel). The state in which all of the wheels 12, 14 are allowed to swivel is sometimes referred to as the “drift state.”

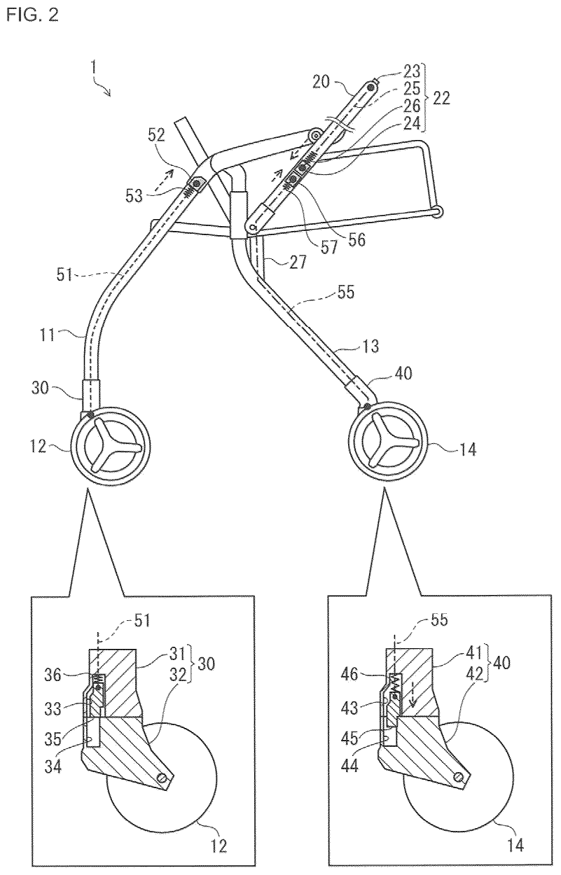

A structure for unlocking and locking the wheels 12, 14 will be described in detail with further reference to FIGS. 2 to 5. To facilitate understanding, the internal structures around the wheels 12, 14 are shown in enlarged views in FIGS. 2 to 5. In figures described below, displacement members 52, 56 and a drive member 24 are shown shaded, and connecting members 25, 51, and 55 are shown by lines different from solid lines (long dashed double-short dashed line, dashed line, and long dashed short dashed line) for better understanding.

As described above, the front-wheel caster mechanism 30 is a mechanism that allows the front wheel 12 to swivel. The front-wheel caster mechanism 30 is provided at the lower end of the front leg 11 and includes a front-wheel caster holding member 31 and a front-wheel caster pivot member 32. The front-wheel caster holding member 31 is fixed to the lower end of the front leg 11, and the front-wheel caster pivot member 32 is disposed under the front-wheel caster holding member 31. The front-wheel caster pivot member 32 is held by the front-wheel caster holding member 31 so as to be pivotable around a pivot axis extending in the up-down direction. The front-wheel caster pivot member 32 supports the front wheel 12 via a shaft.

The rear-wheel caster mechanism 40 is a mechanism that allows the rear wheel 14 to swivel. Like the front-wheel caster mechanism 30, the rear-wheel caster mechanism 40 includes a rear-wheel caster holding member 41 and a rear-wheel caster pivot member 42. The rear-wheel caster holding member 41 is fixed to the lower end of the rear leg 13. The rear-wheel caster pivot member 42 is held by the rear-wheel caster holding member 41 so as to be pivotable around a pivot axis extending in the up-down direction. The rear-wheel caster pivot member 42 supports the rear wheel 13 via a shaft. With this configuration, the rear-wheel caster mechanism 40 allows the rear wheel 14 to swivel.

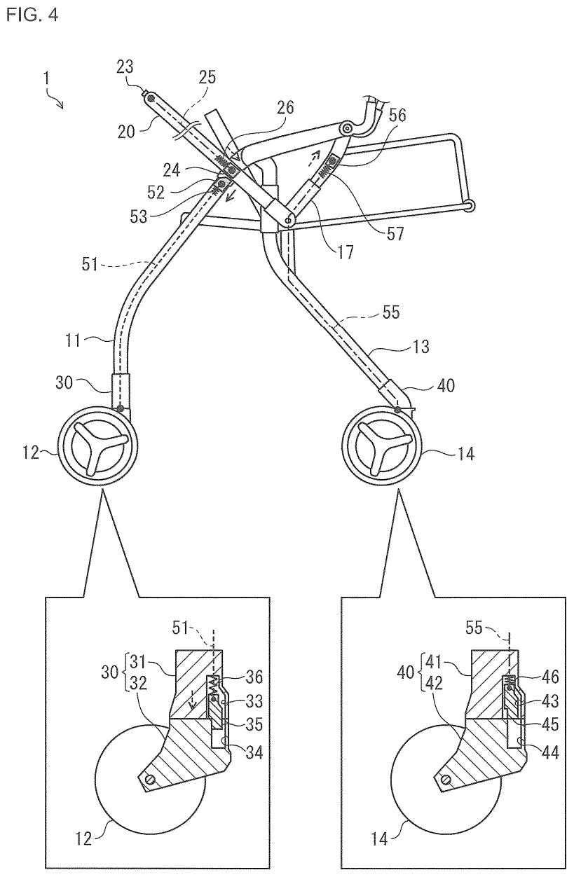

As shown in FIG. 2, the front-wheel caster holding member 31 is provided with a front-wheel first hole 33, a front-wheel caster lock member 35, and a front-wheel third biasing member 36. The front-wheel caster pivot member 32 is provided with a front-wheel second hole 34. The front-wheel second hole 34 connects with the front-wheel first hole 33, forming an elongated hole extending in the up-down direction. The front-wheel caster lock member 35 is displaceable between a lower lock position and an upper unlock position. As shown in FIG. 4, when in the lock position, the front-wheel caster lock member 35 protrudes from within the front-wheel caster holding member 31 into the front-wheel second hole 34 and is engaged with the front-wheel caster pivot member 32. The front-wheel caster lock member 35 thus restricts pivoting of the front-wheel caster pivot member 32 around its pivot axis.

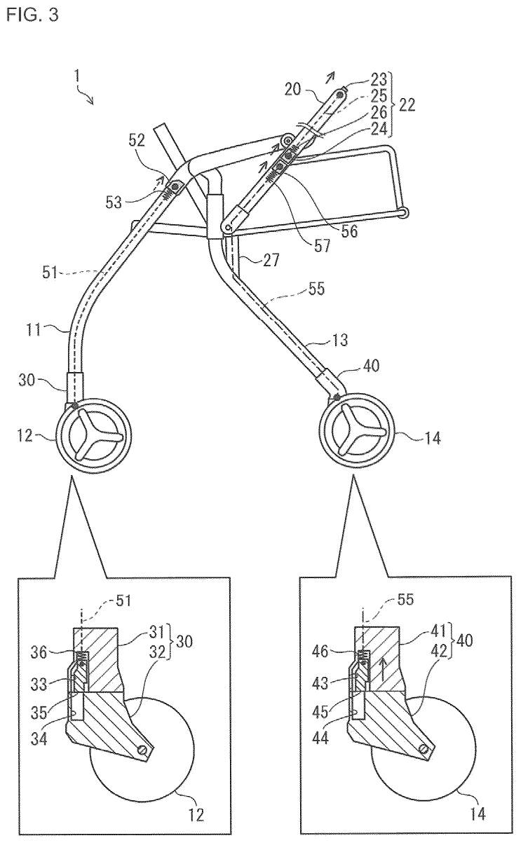

As shown in FIGS. 2 and 3, when in the unlock position, the front-wheel caster lock member 35 is housed in the front-wheel first hole 33 of the front-wheel caster holding member 31 and is disengaged from the front-wheel second hole 34 of the front-wheel caster pivot member 32. The front-wheel caster lock member 35 thus permits pivoting of the front-wheel caster pivot member 32 around its pivot axis. The front-wheel third biasing member 36 is, for example, a spring, and biases the front-wheel caster lock member 35 downward toward the lock position. As an example, the front-wheel third biasing member 36 is disposed between the front-wheel first hole 33 and the upper end of the front-wheel caster lock member 35. However, the position of the front-wheel third biasing member 36, the type of the spring, etc. are not limited to the illustrated example as long as the front-wheel third biasing member 36 biases the front-wheel caster lock member 35 toward the lock position.

As shown in the figures, the rear-wheel caster holding member 41 is provided with a rear-wheel first hole 43, a rear-wheel caster lock member 45, and a rear-wheel third biasing member 46. The rear-wheel caster pivot member 42 is provided with a rear-wheel second hole 44. The rear-wheel second hole 44 connects with the rear-wheel first hole 43, forming an elongated hole extending in the up-down direction. The rear-wheel caster lock member 45 is displaceable between a lower lock position and an upper unlock position. As shown in FIG. 2, when in the lock position, the rear-wheel caster lock member 45 protrudes from within the rear-wheel caster holding member 41 into the rear-wheel second hole 44 and is engaged with the rear-wheel caster pivot member 42. The rear-wheel caster lock member 45 thus restricts pivoting of the rear-wheel caster pivot member 42 around its pivot axis.

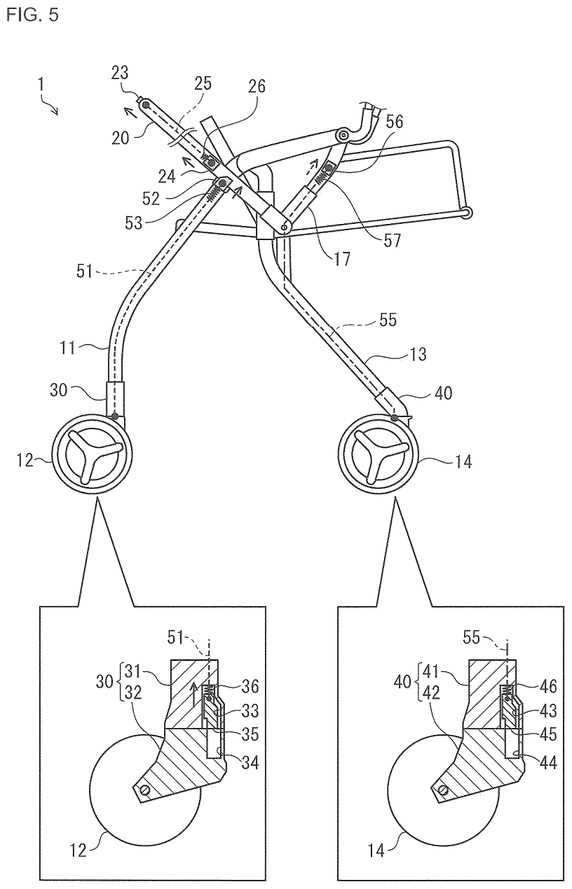

As shown in FIGS. 4 and 5, when in the unlock position, the rear-wheel caster lock member 45 is housed in the rear-wheel first hole 43 of the rear-wheel caster holding member 41 and is disengaged from the rear-wheel caster pivot member 42. The rear-wheel caster lock member 45 thus permits pivoting of the rear-wheel caster pivot member 42 around its pivot axis. The rear-wheel third biasing member 46 is, for example, a spring, and biases the rear-wheel caster lock member 45 downward toward the lock position. As an example, the rear-wheel third biasing member 46 is disposed between the rear-wheel first hole 43 and the upper end of the rear-wheel caster lock member 45. However, the position of the rear-wheel third biasing member 46, the type of the spring, etc. are not limited to the illustrated example as long as the rear-wheel third biasing member 46 biases the rear-wheel caster lock member 45 toward the lock position.

The front-wheel connecting member 51 and the rear-wheel connecting member 55 are displaceably mounted in the body frame 10. The front-wheel connecting member 51 and the rear-wheel connecting member 55 are bendable elongated metal members such as wires. The front-wheel connecting member 51 is passed through the tubular front leg 11. One end of the front-wheel connecting member 51 is coupled to the front-wheel caster lock member 35 inside the front-wheel caster holding member 31. The other end of the front-wheel connecting member 51 is coupled to the front-wheel-side displacement member 52 inside the front leg 11.

As shown in FIG. 2, the rear-wheel connecting member 55 is sequentially passed through the tubular rear leg 13, the reversal bracket 27, and the armrest support member 17. One end of the rear-wheel connecting member 55 is coupled to the rear-wheel caster lock member 45 inside the rear-wheel caster holding member 41. The other end of the rear-wheel connecting member 55 is coupled to the rear-wheel-side displacement member 56 inside the rear leg 13.

As described above, the front-wheel-side displacement member 52 is connected to the front-wheel caster lock member 35 via the front-wheel connecting member 51. The front-wheel-side displacement member 52 is displaced between a first position and a second position according to the switching of the position of the push bar 20. The first position corresponds to the lock position (lower position: FIG. 4) of the front-wheel caster lock member 35, and the second position corresponds to the unlock position (upper position: FIG. 2) of the front-wheel caster lock member 35. The front-wheel-side displacement member 52 is also displaced between the first position and the second position by operating the operation mechanism 22 when in the rear-facing position.

The front-wheel-side displacement member 52 is movable up and down along the body frame 10, specifically, at least along the front leg 11. The front-wheel-side displacement member 52 is a member that moves up and down along the outer periphery of the tubular front leg 11. The specific shape of the front-wheel-side displacement member 52 is not limited. The front-wheel-side displacement member 52 may have any shape as long as it is coupled to at least the front-wheel connecting member 51 and transmits its own displacement to the front-wheel caster lock member 35.

The front-wheel-side displacement member 52 is biased toward the second position by a front-wheel-side first biasing member 53. The front-wheel-side displacement member 52 thus moves the front-wheel caster lock member 35 to the unlock position (upper position: FIG. 2). The front-wheel-side first biasing member 53 is, for example, a spring. The biasing force of the front-wheel-side first biasing member 53 is greater than the biasing force of the front-wheel third biasing member 36 of the front-wheel caster mechanism 30. Therefore, as shown in FIGS. 2 and 3, when the drive member 24 of the operation mechanism 22 is not in contact with the front-wheel-side displacement member 52, the front-wheel caster lock member 35 is located in the unlock position (upper position: FIG. 2) due to the biasing force of the front-wheel-side first biasing member 53.

As described above, the rear-wheel-side displacement member 56 is connected to the rear-wheel caster lock member 45 via the rear-wheel connecting member 55. The rear-wheel-side displacement member 56 is displaced between a first position and a second position according to the switching of the position of the push bar 20. The first position corresponds to the lock position (lower position: FIG. 2) of the rear-wheel caster lock member 45, and the second position corresponds to the unlock position (upper position: FIG. 3) of the rear-wheel caster lock member 45. The rear-wheel-side displacement member 56 is also displaced between the first position and the second position by operating the operation mechanism 22.

As shown in FIG. 4, the rear-wheel-side displacement member 56 is movable up and down along the body frame 10, specifically, along the armrest support member 17. The rear-wheel-side displacement member 56 is a member that moves up and down along the outer periphery of the tubular armrest support member 17. The specific shape of the rear-wheel-side displacement member 56 is not limited. The rear-wheel-side displacement member 56 may have any shape as long as it is coupled to at least the rear-wheel connecting member 55 and transmits its own displacement to the rear-wheel caster lock member 45. The rear-wheel-side displacement member 56 is provided on the body frame 10 at a position separated from the front-wheel-side displacement member 52. Specifically, the front-wheel-side displacement member 52 is provided on the front leg 11, and the rear-wheel-side displacement member 56 is provided on the armrest support member 17 on the rear leg 13 side. The front-wheel-side displacement member 52 and the rear-wheel-side displacement member 56 are thus substantially spaced apart from each other. However, the front-wheel-side displacement member 52 and the rear-wheel-side displacement member 56 may be positioned in any manner as long as they are not coupled to each other. The front-wheel-side displacement member 52 and the rear-wheel-side displacement member 56 may be disposed close to each other or may be in contact with each other.

The rear-wheel-side displacement member 56 is biased toward the second position (upper position) by a rear-wheel-side first biasing member 57. The rear-wheel-side displacement member 56 thus moves the rear-wheel caster lock member 45 to the unlock position (upper position: FIG. 3). The rear-wheel-side first biasing member 57 is, for example, a spring. The biasing force of the rear-wheel-side first biasing member 57 is greater than the biasing force of the rear-wheel third biasing member 46 of the rear-wheel caster mechanism 40. Therefore, as shown in FIGS. 4 and 5, when the drive member 24 of the operation mechanism 22 is not in contact with the rear-wheel-side displacement member 56, the rear-wheel connecting member 55 is pulled up by the biasing force of the rear-wheel-side first biasing member 57, and the rear-wheel caster lock member 45 is therefore located in the unlock position (upper position: FIG. 3).

As described above, the operation mechanism 22 is provided on top of the push bar 20 that is switchable between the front-facing position (FIG. 1(A)) and the rear-facing position (FIG. 1(B)). The operation mechanism 22 is configured to operate the front-wheel-side displacement member 52 and the rear-wheel-side displacement member 56 to switch them from the first position to the second position. Specifically, the operation mechanism 22 is configured to operate the rear-wheel-side displacement member 56 when in the front-facing position, and is configured to operate the front-wheel-side displacement member 52 when in the rear-facing position. As used herein, the expression “configured to operate” is intended to include not only direct operation through connection, but also indirect operation through action on the other component.

The operation mechanism 22 includes an operation member 23 and the drive member 24. The drive member 24 is connected to the operation member 23 and is switched by the operating force of the operation member 23. The operation member 23 is provided on top of the push bar 20 and is, for example, a pressable button, a lever that can be pulled up, etc. The operation member 23 is connected to the drive member 24 via the operation connecting member 25. The drive member 24 is switched between a first state (lower state: FIGS. 3 and 5) and a second state (upper state: FIGS. 2 and 4). The drive member 24 is biased to the first state (lower state) by a second biasing member 26. The second biasing member 26 is, for example, a spring. The biasing force of the second biasing member 26 is greater than the biasing force of the rear-wheel-side first biasing member 57 and the biasing force of the front-wheel-side first biasing member 53. From the above, the biasing forces of the biasing members provided in the stroller 1 have the following relationship.

(front-wheel third biasing member 36=rear-wheel third biasing member 46)<(front-wheel-side first biasing member 53=rear-wheel-side first biasing member 57)<second biasing member 26

When in the front-facing position in FIG. 2, the drive member 24 in the first state moves the rear-wheel-side displacement member 56 to the first position (lower position). As described above, the biasing force of the second biasing member 26 of the operation mechanism 22 is greater than the biasing force of the rear-wheel-side first biasing member 57. Therefore, the drive member 24 in the first state counteracts the biasing force of the rear-wheel-side first biasing member 57 on the rear-wheel-side displacement member 56. That is, the biasing force applied from the rear-wheel-side first biasing member 57 to the rear-wheel-side displacement member 56 is overcome by the biasing force applied from the second biasing member 26 to the drive member 24. As a result, the rear-wheel-side displacement member 56 is moved downward along with the drive member 24 due to the biasing force applied from the second biasing member 26 to the drive member 24. The rear-wheel caster lock member 45 is thus located in the lock position.

When in the front-facing position in FIG. 3, the drive member 24 in the second state moves the rear-wheel-side displacement member 56 to the second position (upper position). As described above, the biasing force of the second biasing member 26 of the operation mechanism 22 is greater than the biasing force of the rear-wheel-side first biasing member 57. However, the biasing force applied from the second biasing member 26 to the drive member 24, namely the biasing force that counteracts the biasing force of the rear-wheel-side first biasing member 57 on the rear-wheel-side displacement member 56, is not exerted unless the drive member 24 comes into contact with the rear-wheel-side displacement member 56. Therefore, the drive member 24 in the second state allows the biasing force of the rear-wheel-side first biasing member 57 on the rear-wheel-side displacement member 56 to act effectively. In other words, the operation member 23 is operated to move the drive member 24 upward against the biasing force of the second biasing member 26. As a result, the rear-wheel-side displacement member 56 is moved upward by the biasing force of the rear-wheel-side first biasing member 57. The rear-wheel caster lock member 45 is thus located in the unlock position. Although the drive member 24 is not directly connected to the rear-wheel-side displacement member 56, the rear-wheel-side displacement member 56 is indirectly operated by the operation mechanism 22 in this manner.

### Operation

The operation of restricting or permitting pivoting of the caster mechanisms 30, 40 of the stroller 1 according to the present embodiment will be described with reference to FIGS. 2 to 5. FIGS. 2 and 3 show the push bar 20 in the front-facing position. FIG. 2 shows the in which the operation mechanism 22 is not operated, and FIG. 3 shows a state in which the operation mechanism 22 is operated. FIGS. 4 and 5 show the push bar 20 is the rear-facing position. FIG. 4 shows a state in which the operation mechanism 22 is not operated, and FIG. 5 shows a state in which the operation mechanism 22 is operated.

First, the operation when the push bar 20 is in the front-facing position will be described with reference to FIGS. 2 and 3. As shown in FIG. 2, when the push bar 20 is in the front-facing position, the front-wheel caster mechanism 30 is allowed to pivot around its pivot axis, and the rear-wheel caster mechanism 40 is not allowed to pivot around its pivot axis. Specifically, regarding the front-wheel caster mechanism 30, the front-wheel-side displacement member 52 is biased upward by the front-wheel-side first biasing member 53. Therefore, the front-wheel caster lock member 35 is located in the unlock position (upper position).

Regarding the rear-wheel caster mechanism 40, the drive member 24 of the operation mechanism 22 on the push bar 20 and the rear-wheel-side displacement member 56 on the armrest support member 17 are in contact with each other in the up-down direction. Since the biasing force of the second biasing member 26 on the drive member 24 is greater than the biasing force of the rear-wheel-side first biasing member 57 on the rear-wheel-side displacement member 56, the drive member 24 counteracts the biasing force of the rear-wheel-side first biasing member 57 on the rear-wheel-side displacement member 56. As a result, the rear-wheel-side displacement member 56 is biased downward by the biasing force applied from the second biasing member 26 to the drive member 24. The rear-wheel caster lock member 45 is thus located in the lock position (lower position).

As shown in FIG. 3, to allow not only the front-wheel caster mechanism 30 but also the rear-wheel caster mechanism 40 to pivot about their pivot axes and attain the drift state when the push bar 20 is in the front-facing position, the operation member 23 is operated. Specifically, the operation member 23 is operated to pull up the operation connecting member 25. The drive member 24 is thus switched to the second state. As a result, the rear-wheel-side displacement member 56 is moved upward by the rear-wheel-side first biasing member 57, and the rear-wheel caster lock member 45 is therefore moved to the unlock position (upper position). As described above, by operating the operation mechanism 22, not only the front-wheel caster mechanism 30 but also the rear-wheel caster mechanism 40 are allowed to pivot about their pivot axes, and the drift state can be attained.

Next, the operation when the push bar 20 is in the rear-facing position will be described with reference to FIGS. 4 and 5. As shown in FIG. 4, when the push bar 20 is in the rear-facing position, the rear-wheel caster mechanism 40 is allowed to pivot around its pivot axis, and the front-wheel caster mechanism 30 is not allowed to pivot around its pivot axis.

Specifically, regarding the front-wheel caster mechanism 30, the front-wheel-side displacement member 52 is biased upward by the front-wheel-side first biasing member 53, but contacts the drive member 24 on the push bar 20 displaced to the rear-facing position. Since the biasing force of the second biasing member 26 on the drive member 24 is greater than the biasing force of the front-wheel-side first biasing member 53 on the front-wheel-side displacement member 52, the drive member 24 counteracts the biasing force of the front-wheel-side first biasing member 53 on the front-wheel-side displacement member 52. As a result, the front-wheel-side displacement member 52 is biased downward by the force applied from the second biasing member 26 to the drive member 24. The front-wheel caster lock member 35 is thus located in the lock position (lower position).

Regarding the rear-wheel caster mechanism 40, since the push bar 20 is displaced to the rear-facing position, the rear-wheel-side displacement member 56 on the armrest support member 17 is not in contact with the drive member 24 of the operation mechanism 22. That is, the rear-wheel-side displacement member 56 is in a free state. Therefore, the rear-wheel-side displacement member 56 is biased upward by the rear-wheel-side first biasing member 57. The rear-wheel caster lock member 45 is thus located in the unlock position (upper position).

To allow not only the rear-wheel caster mechanism 40 but also the front-wheel caster mechanism 30 to pivot about their pivot axes and attain the drift state when the push bar 20 is in the rear-facing position, the operation member 23 is operated. As shown in FIG. 5, the operation member 23 is operated to pull up the operation connecting member 25. The drive member 24 is thus switched to the second state. As a result, the front-wheel-side displacement member 52 is moved upward by the front-wheel-side first biasing member 53, and the front-wheel caster lock member 35 is therefore moved to the unlock position (upper position). As described above, by operating the operation mechanism 22, not only the rear-wheel caster mechanism 40 but also the front-wheel caster mechanism 30 are allowed to pivot about their pivot axes, and the drift state can be attained.

### Effects

As described above, the stroller 1 of the present embodiment restricts and permits pivoting of the caster mechanisms 30, 40 by merely using the caster mechanisms 30, 40, the displacement members 52, 56 respectively connected to the caster mechanisms 30, 40 via the connecting members 51, 55, and the operation mechanism 22 configured to operate the displacement members 52, 56. This configuration reduces the number of parts and realizes a simple structure.

In conventional strollers, a wire connecting caster lock mechanisms of the front and rear wheels is needed to restrict and permit pivoting of the caster lock mechanisms simultaneously. On the other hand, the stroller 1 of the present embodiment does not need a wire connecting the caster lock members 35, 45 of the front and rear wheels 12, 14. The stroller 1 of the present embodiment thus has a simple structure even from the standpoint of reducing wire routing.

In conventional strollers, the caster lock mechanisms that restrict pivoting of the front and rear wheels are directly connected to the operation member on the push bar via a wire. Therefore, the operating force of the operation member is directly transmitted to the caster lock mechanisms. Accordingly, when the caster lock member is in the lock position and in contact with the wall surface of the hole, and the operation member is operated to move the caster lock member to the unlock position, this operation causes resistance between the caster lock member and the wall surface of the hole, and this resistance is transmitted directly to the operation member through the wire. Therefore, the caster lock mechanism cannot be unlocked even though the operation member is operated, resulting in a poor user experience. Moreover, if the resistance is strong, the wire may break, leading to a malfunction.

On the other hand, in the stroller 1 of the present embodiment, the caster mechanisms 30, 40 are not connected to the operation mechanism 22. This allows the operating force of the operation mechanism 22 not to be directly transmitted to the caster mechanisms 30, 40. Specifically, the biasing forces of the first biasing members 53, 57 that respectively bias the displacement members 52, 56 are allowed to be exerted by operating the operation mechanism 22. Therefore, even when resistance occurs between the caster lock member 35 and the wall surfaces of the holes 33, 34 and between the caster lock member 45 and the wall surfaces of the holes 43, 44, the caster lock members 35, 45 are always biased upward with a constant force by the first biasing members 53, 57, respectively. Accordingly, when the operation mechanism 22 is operated to displace the displacement members 52, 56 to the upper position, the caster lock members 35, 45 can be located in the unlock position as the caster lock members 35, 45 align with the position between the holes 33, 34 and the position between the holes 43, 44, respectively. As described above, the stroller 1 of the present embodiment can improve operability in permitting pivoting of the caster mechanisms 30, 40 and can also reduce the possibility of component malfunctions.

### Modifications

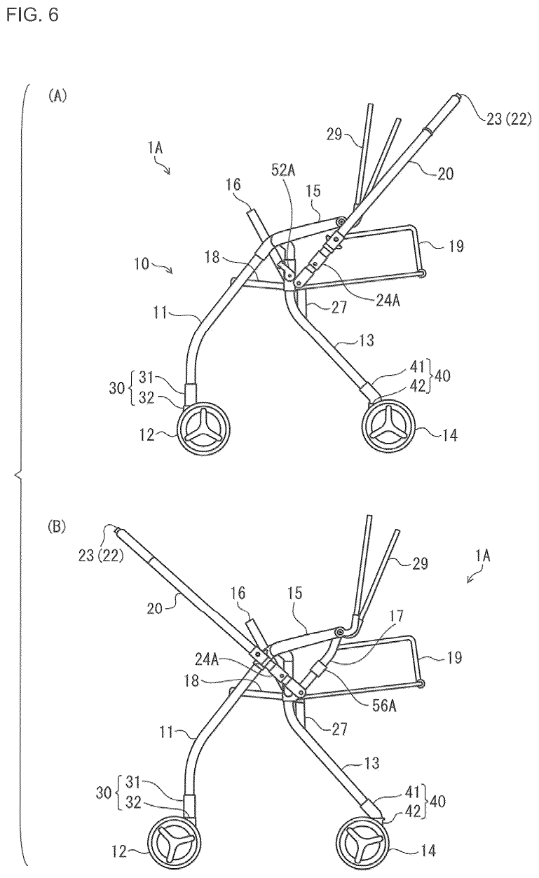

Modifications of the stroller according to the first embodiment will be described with reference to FIGS. 6 to 8. The front-wheel-side displacement member 52 of the embodiment is provided on the front leg 11. However, the front-wheel-side displacement member 52 may be provided on the rear leg 13.

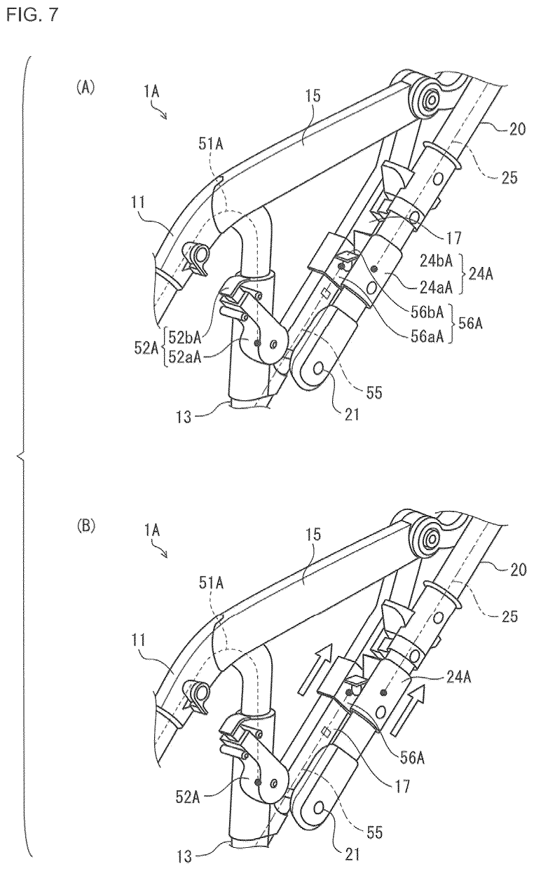

A front-wheel-side displacement member 52A of a stroller 1A is provided on the upper part of the rear leg 13 so as to protrude outward in the width direction of the stroller 1A (toward the push bar 20). As shown in FIG. 7(A), the front-wheel-side displacement member 52A includes a body 52aA and a protruding portion 52bA protruding upward from the body 52aA. The front-wheel-side displacement member 52A is connected to a front-wheel connecting member 51A. The front-wheel connecting member 51A passes through the front leg 11 and the upper part of the rear leg in this order.

As in the embodiment, a rear-wheel-side displacement member 56A is provided on the armrest support member 17 so as to be movable up and down. Like the rear-wheel-side displacement member 56, the rear-wheel-side displacement member 56A is provided so as to protrude in the width direction of the stroller 1. Specifically, the rear-wheel-side displacement member 56A includes a body 56aA that is slidable along the armrest support member 17, and a stopper 56bA protruding outward in the width direction from the body 56aA. The protruding portion 52bA of the front-wheel-side displacement member 52A and the stopper 56bA of the rear-wheel-side displacement member 56 are positioned such that their straight-line distances from the swing shaft 21 of the push bar 20 are substantially the same.

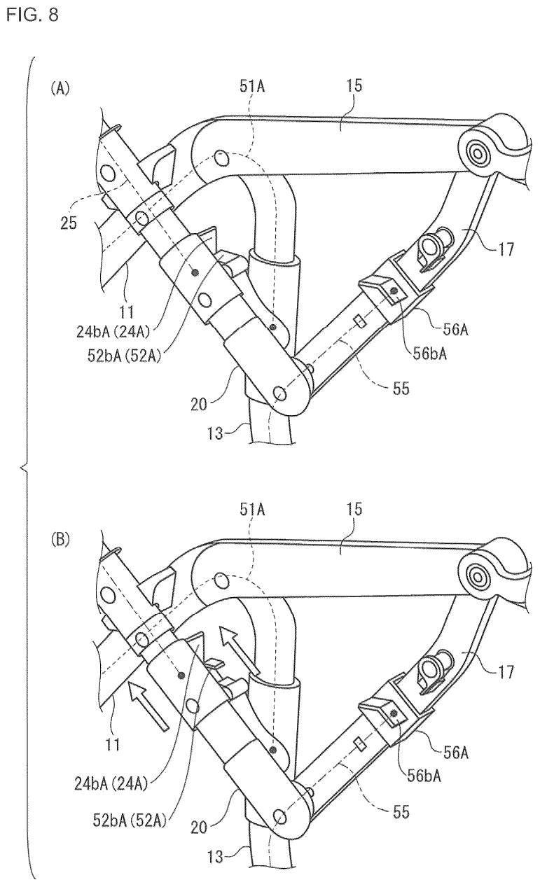

A drive member 24A provided on the push bar 20 includes a body 24aA that is slidable along the push bar 20, and a stopper 24bA protruding inward in the width direction from the body 24aA. When in the front-facing position shown in FIGS. 7(A) and 7(B), the stopper 24bA of the drive member 24 and the stopper 56bA of the rear-wheel-side displacement member 56A contact each other in the up-down direction. When in the rear-facing position shown in FIGS. 8(A) and 8(B), the stopper 24bA of the drive member 24 and the protruding portion 52bA of the front-wheel-side displacement member 52A contact each other in the up-down direction. As described above, the displacement members 52A, 56A are exposed to the outside of the body frame 10 and protrude outward in the width direction (toward the push bar 20), and the drive member 24A protrudes inward in the width direction (toward the body frame 10). With this configuration, the displacement members 52A, 56A can be easily brought into contact with the drive member 24A.

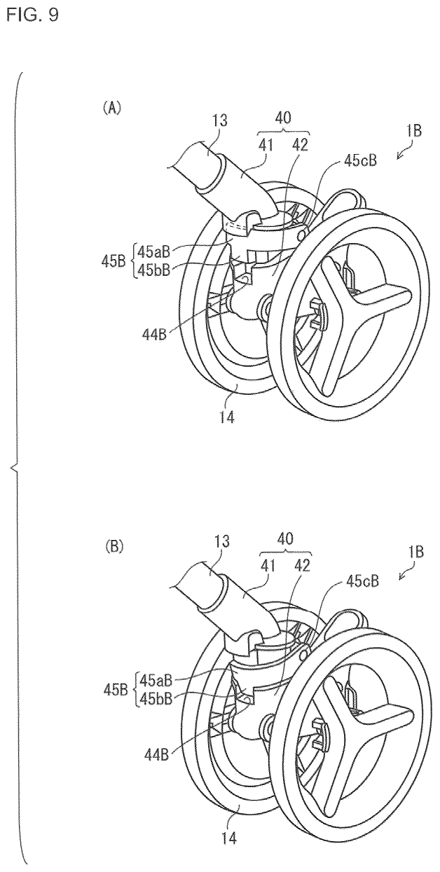

A modification of the caster lock member of the first embodiment will be described with reference to FIG. 9. The caster lock members 35, 45 of the embodiment are rod-shaped members that are long in the up-down direction, and are not exposed to the outside. However, as shown in FIG. 9, the caster lock member may be exposed to the outside. Since the front-wheel caster lock member 35 and the rear-wheel caster lock member 45 have the same shape, only a rear-wheel caster lock member 45B will be described.

As shown in FIG. 9, the rear-wheel caster lock member 45B of a stroller 1B is attached to the outer peripheral surface of the rear-wheel caster mechanism 40, and is supported by, for example, the rear-wheel caster holding member 41, via a shaft. Although not shown in the figures, the rear-wheel connecting member 55 described in the embodiment is connected to the rear-wheel caster lock member 45B. The rear-wheel caster lock member 45B includes a body 45aB having an arc shape and conforming to the outer periphery of the rear-wheel caster holding member 41, and a protrusion 45bB protruding downward from the body 45aB. The body 45aB is pivotable in the up-down direction around a shaft 45cB. As shown in FIG. 9(B), the rear-wheel caster lock member 45B is locked when the body 45aB is pivoted downward and fitted in a recess 44B of the rear-wheel caster pivot member 42.

### Second Embodiment

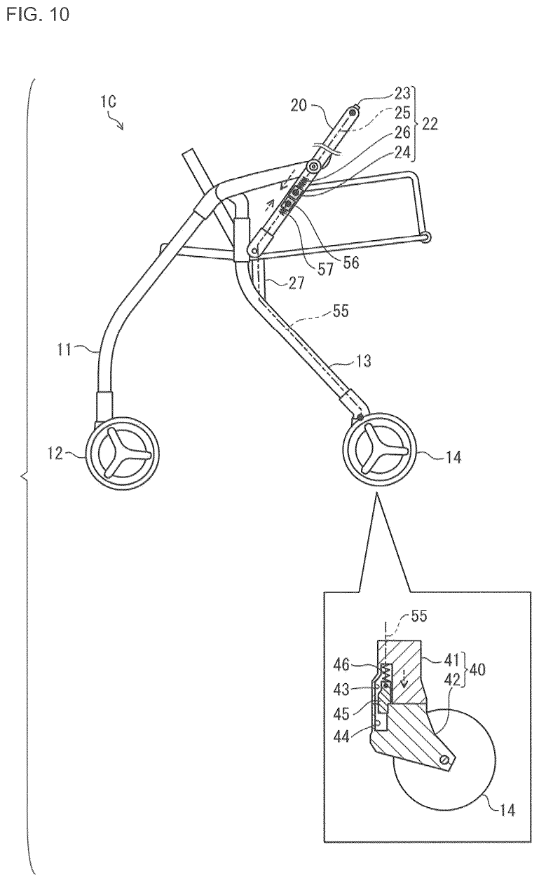

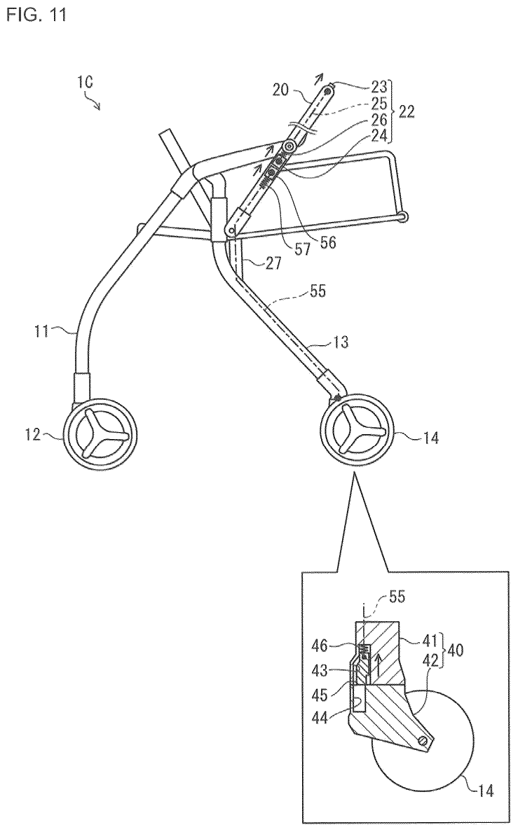

The configuration and operation of a stroller 1C according to a second embodiment will be described with reference to FIGS. 10 and 11. The stroller 1C of the present embodiment is basically the same in configuration as the first embodiment. The stroller 1C is different from the first embodiment in that the push bar 20 is fixed in the front-facing position, and the displacement members are provided only for the rear wheels 14. Only the differences from the configuration of the first embodiment will be described in detail.

### Configurations

In the stroller 1C of the present embodiment, both the front wheels 12 and the rear wheels 14 are caster wheels. However, only the rear wheels 14 are provided with the caster lock member 45 that restricts pivoting of the rear wheel 14 around its pivot axis. The stroller 1C illustrated in FIG. 10 is foldable.

The stroller 1C shown in FIGS. 10 and 11 includes at least the rear-wheel caster mechanism 40, the rear-wheel caster lock member 45, the rear-wheel-side displacement member 56, the rear-wheel-side first biasing member 57, and the drive member 24 provided on the push bar 20, which are described regarding the stroller 1 of the first embodiment. As in the first embodiment, the drive member 24 of the present embodiment is operated by the operation mechanism 22.

### Operation

As shown in FIG. 10, the drive member 24 of the operation mechanism 22 provided on the push bar 20 and the rear-wheel-side displacement member 56 provided on the armrest support member 17 are in contact with each other in the up-down direction. Since the biasing force of the second biasing member 26 on the drive member 24 is greater than the biasing force of the rear-wheel-side first biasing member 57 on the rear-wheel-side displacement member 56, the drive member 24 counteracts the biasing force of the rear-wheel-side first biasing member 57 on the rear-wheel-side displacement member 56. As a result, the rear-wheel-side displacement member 56 is biased downward by the biasing force applied from the second biasing member 26 to the drive member 24. The rear-wheel caster lock member 45 is thus located in the lock position (lower position).

As shown in FIG. 11, to allow the rear-wheel caster mechanism 40 to pivot about its pivot axis and attain the drift state when the push bar 20 is in the front-facing position, the operation member 23 is operated. Specifically, the operation member 23 is operated to pull up the operation connecting member 25. As a result, the drive member 24 is moved upward against the biasing force of the second biasing member 26. Accordingly, the rear-wheel-side displacement member 56 is moved upward by the biasing force of the rear-wheel-side first biasing member 57, and the rear-wheel connecting member 55 is pulled up. As a result, the rear-wheel caster lock member 45 is moved to the unlock position (upper position). As described above, by operating the operation mechanism 22, the rear-wheel caster mechanism 40 can be allowed to pivot about its pivot axis.

### Modifications

In the present embodiment, the drive member 24 forms part of the operation mechanism 22 and is operated by the operation member 23. However, the drive member 24 may not be configured to be operated by the operation member 23 as long as the drive member 24 switches the rear-wheel-side displacement member 56 from the first position to the second position. For example, the drive member 24 may be configured such that it can be moved up and down directly along the push bar 20, or may be configured such that it can be manually moved upward only when it is desired to allow the rear-wheel caster mechanism 40 to pivot around its pivot axis.

In the stroller 1C of the present embodiment, the push bar 20 is fixed in the front-facing position and the stroller 1C is foldable. However, the push bar 20 may be switchable between the front-facing position and the rear-facing position, and the stroller 1C may be non-foldable. A non-foldable stroller is not provided with the reversal bracket 27. Therefore, when the stroller 1C is non-foldable, the rear-wheel connecting member 55 may pass through the rear leg 13 and the lower end portion of the push bar 20 in this order, and the rear-wheel-side displacement member 56 may be provided at the lower end of the push bar 20.

In the stroller 1C of the present embodiment, the rear-wheel-side caster lock member 45, the rear-wheel-side displacement member 56, and the rear-wheel-side first biasing member 57 are provided only for the rear wheel 14. However, these configurations for the rear leg 13 may not be provided. The front-wheel caster lock member 35, the front-wheel-side displacement member 52, and the front-wheel-side first biasing member 53 may be disposed on the front leg 11 so that the drift state can be attained only when it is desired to switch the push bar 20 to the rear-facing position.

### Third Embodiment

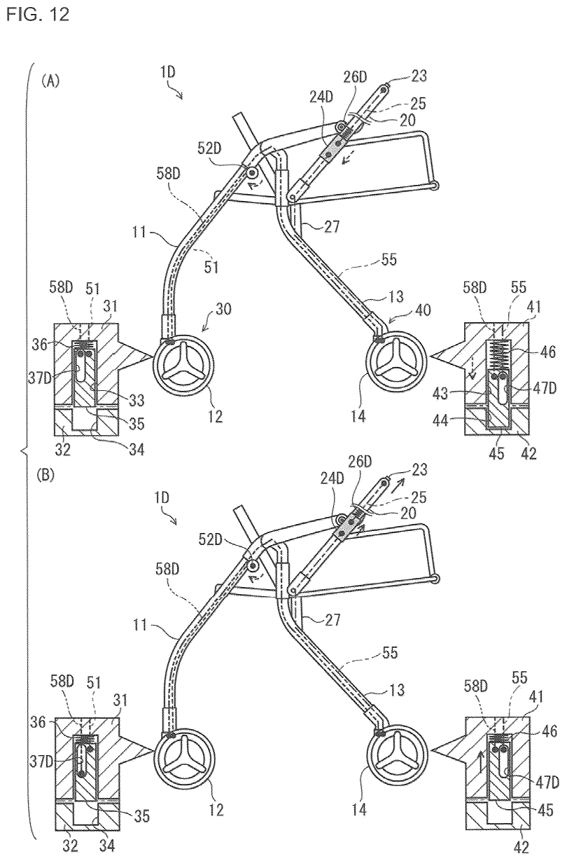

The configuration and operation of a stroller 1D according to a third embodiment will be described with reference to FIGS. 12 to 15. The stroller 1D of the present embodiment is basically the same in configuration as the first embodiment. The major difference is that the stroller 1D is provided with an inter-wheel connecting member 58D that connects the front-wheel caster lock member 35 and the rear-wheel caster lock member 45. Only the differences from the configuration of the first embodiment will be described in detail.

### Configurations

The stroller 1D of the present embodiment is provided with the inter-wheel connecting member 58D that connects the front-wheel caster lock member 35 and the rear-wheel caster lock member 45. The inter-wheel connecting member 58D sequentially passes through the front leg 11 and the rear leg 13. Therefore, not only the front-wheel connecting member 51 connected to a front-wheel-side displacement member 52D but also one end of the inter-wheel connecting member 58D are connected to the front-wheel caster lock member 35. Moreover, not only the rear-wheel connecting member 55 connected to a rear-wheel-side displacement member 56D but also to the other end of the inter-wheel connecting member 58D are connected to the rear-wheel caster lock member 45. Like the front-wheel connecting member 51 and the rear-wheel connecting member 55, the inter-wheel connecting member 58D is a bendable elongated metal member such as a wire.

The front-wheel caster lock member 35 has a front-wheel elongated hole 37D at the connection point with the inter-wheel connecting member 58D. The rear-wheel caster lock member 45 has a rear-wheel elongated hole 47D at the connection point with the rear-wheel connecting member 55.

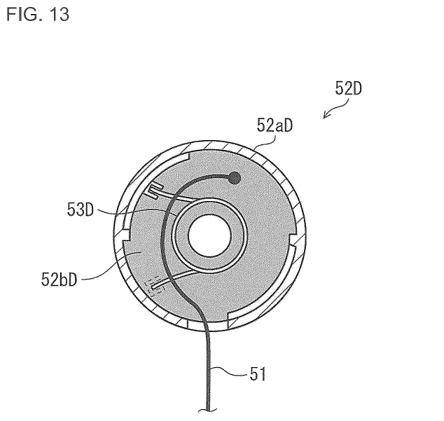

The front-wheel-side displacement member 52D of the present embodiment is provided so as to be pivotable relative to the front leg 11. As shown in FIG. 13, the front-wheel-side displacement member 52D includes a case 52aD attached to the front leg 11 and a rotating body 52bD that rotates on its own axis relative to the case 52aD. The rotating body 52bD is shown shaded in FIG. 13. The front-wheel connecting member 51 is fixed to the rotating body 52bD. The rotating body 52bD is rotated clockwise by a front-wheel-side first biasing member 53D and is biased in such a direction that the rotating body 52bD winds up the front-wheel connecting member 51 (clockwise). The front-wheel-side first biasing member 53D is, for example, a spring, and a torsion spring is shown in FIG. 13. The front-wheel-side first biasing member 53D is provided between the case 52aD and the rotating body 52bD. One end of the front-wheel-side first biasing member 53D is fixed to the rotating body 52bD, and the other end thereof is fixed to the case 52aD.

As shown in FIG. 12, one end of a drive member 24D of the present embodiment is connected to the operation connecting member 25 connected to the operation member 23, and the other end of the drive member 24D is connected to the rear-wheel caster lock member 45 via the rear-wheel connecting member 55. The drive member 24D is provided on the push bar 20. The rear-wheel connecting member 55 that connects the drive member 24D and the rear-wheel caster lock member 45 is thus passed through the rear leg 13, the reversal bracket 27, and the push bar 20 in this order. The drive member 24D is biased toward the lower position by a second biasing member 26D.

### Operation

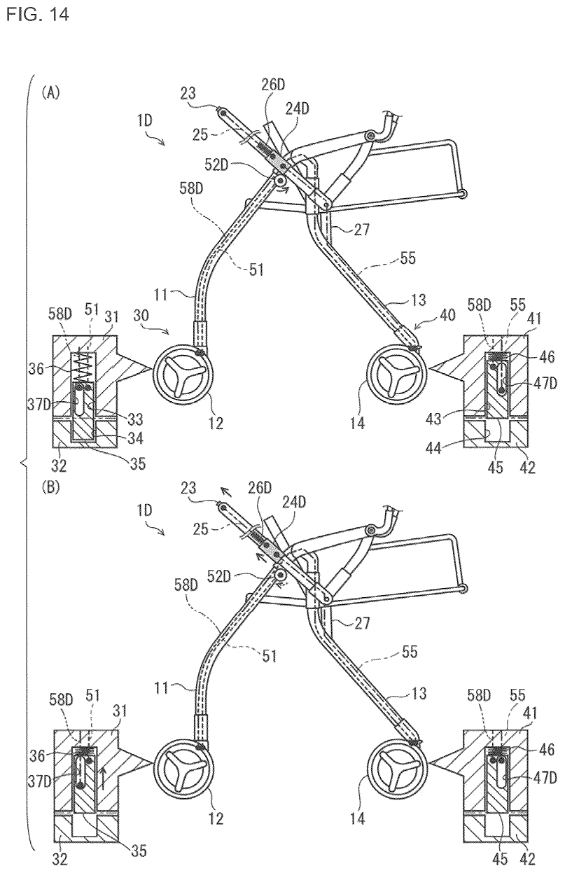

The operation of restricting or permitting pivoting of the caster mechanisms 30, 40 of the stroller 1D according to the present embodiment will be described with reference to FIGS. 12 to 15. FIG. 12 shows the push bar 20 in the front-facing position. FIG. 12(A) shows a state in which the operation mechanism 22 is not operated, and FIG. 12(B) shows a state in which the operation mechanism 22 is operated. FIG. 14 shows the push bar 20 is the rear-facing position. FIG. 14(A) shows a state in which the operation mechanism 22 is not operated, and FIG. 14(B) shows a state in which the operation mechanism 22 is operated.

First, the operation when the push bar 20 is in the front-facing position will be described with reference to FIGS. 12(A) and 12(B). As shown in FIG. 12(A), when the push bar 20 is in the front-facing position, the front-wheel caster mechanism 30 is allowed to pivot around its pivot axis, and the rear-wheel caster mechanism 40 is not allowed to pivot around its pivot axis. As shown in FIG. 13, since the front-wheel-side displacement member 52D is biased clockwise by the front-wheel-side first biasing member 53D, the front-wheel-side displacement member 52D winds up the front-wheel connecting member 51, and the front-wheel caster lock member 35 of the front-wheel caster mechanism 30 is moved to the unlock position (upper position).

In the rear-wheel caster mechanism 40, the drive member 24D is biased downward by the biasing force of the second biasing member 26D, and the rear-wheel caster lock member 45 is located in the lock position (lower position). At this time, the other end of the rear-wheel connecting member 55 is located in the upper part of the rear-wheel elongated hole 47D of the rear-wheel caster lock member 45.

To allow not only the front-wheel caster mechanism 30 but also the rear-wheel caster mechanism 40 to pivot about their pivot axes and attain the drift state when the push bar 20 is in the front-facing position, the operation member 23 is operated. As shown in FIG. 12(B), the operation member 23 is operated to pull up the operation connecting member 25. The drive member 24D is thus moved upward against the biasing force of the second biasing member 26D, and the rear-wheel caster lock member 45 is therefore moved to the unlock position (upper position). As described above, by operating the operation mechanism 22, not only the front-wheel caster mechanism 30 but also the rear-wheel caster mechanism 40 are allowed to pivot about their pivot axes, and the drift state can be attained. When the push bar 20 is in the front-facing position, the front-wheel caster lock member 35 is not moved even when the operation member 23 is operated. This is because the front-wheel caster lock 35 has the front-wheel elongated hole 37D.

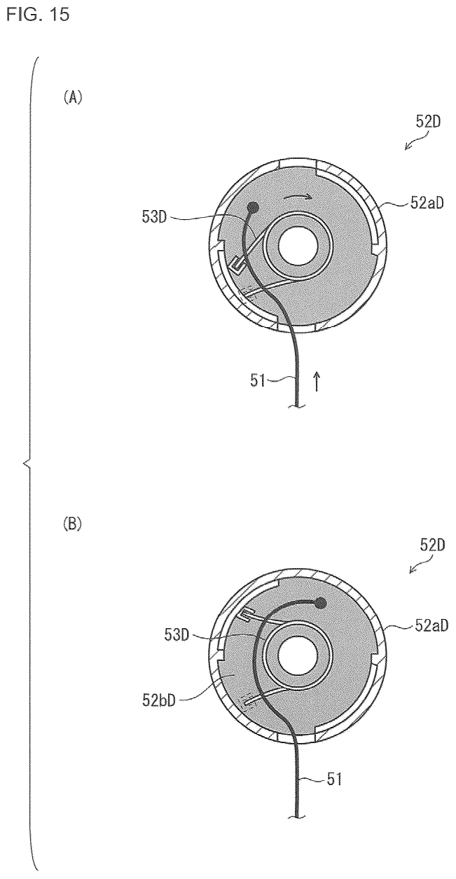

Next, the operation when the push bar 20 is in the rear-facing position will be described with reference to FIGS. 14 and 15. As shown in FIG. 14(A), when the push bar 20 is in the rear-facing position, the rear-wheel caster mechanism 40 is allowed to pivot around its pivot axis, and the front-wheel caster mechanism 30 is not allowed to pivot around its pivot axis.

Specifically, when the front-wheel-side displacement member 52D comes into contact with the drive member 24D provided on the push bar 20 displaced to the rear-facing position as shown in FIG. 14(A), the front-wheel-side displacement member 52D is rotated counterclockwise, namely in such a direction that the front-wheel-side displacement member 52D feeds out the front-wheel connecting member 51, as shown in FIGS. 15(A) and 15(B). At this time, the front-wheel-side displacement member 52D is biased clockwise by the front-wheel-side first biasing member 53D. However, this biasing force is counteracted because the drive member 24 contacts the front-wheel-side displacement member 52D. As shown in FIG. 14(A), the front-wheel-side displacement member 52 feeds out the front-wheel connecting member 51, and the front-wheel caster lock member 35 is moved to the lock position (lower position) by the biasing force of the front-wheel third biasing member 36.

Since the front-wheel caster lock member 35 and the rear-wheel caster lock member 45 are connected by the inter-wheel connecting member 58D, the rear-wheel caster lock member 45 is pulled up to the unlock position (upper position) by the inter-wheel connecting member 58D.

To allow not only the rear-wheel caster mechanism 40 but also the front-wheel caster mechanism 30 to pivot about their pivot axes and attain the drift state when the push bar 20 is in the rear-facing position, the operation member 23 is operated. As shown in FIG. 14(B), the operation member 23 is operated to pull up the operation connecting member 25. The drive member 24D is thus moved upward and is no longer in contact with the front-wheel-side displacement member 52D, which allows the biasing force of the front-wheel-side biasing member 53D to act effectively.

As shown in FIGS. 15(B) and 15(A) in this order, the rotating body 52bD of the front-wheel-side displacement member 52D is rotated clockwise by the biasing force of the front-wheel-side first biasing member 53D to pull up the front-wheel connecting member 51. As a result, as shown in FIG. 14(B), the front-wheel caster lock member 45 is moved to the unlock position (upper position). As described above, by operating the operation mechanism 22, not only the rear-wheel caster mechanism 40 but also the front-wheel caster mechanism 30 are allowed to pivot about their pivot axes, and the drift state can be attained. When the push bar 20 is in the rear-facing position, the rear-wheel caster lock member 45 is not moved even when the operation member 23 is operated. This is because the rear-wheel caster lock 45 has the rear-wheel elongated hole 47D.

### Fourth Embodiment

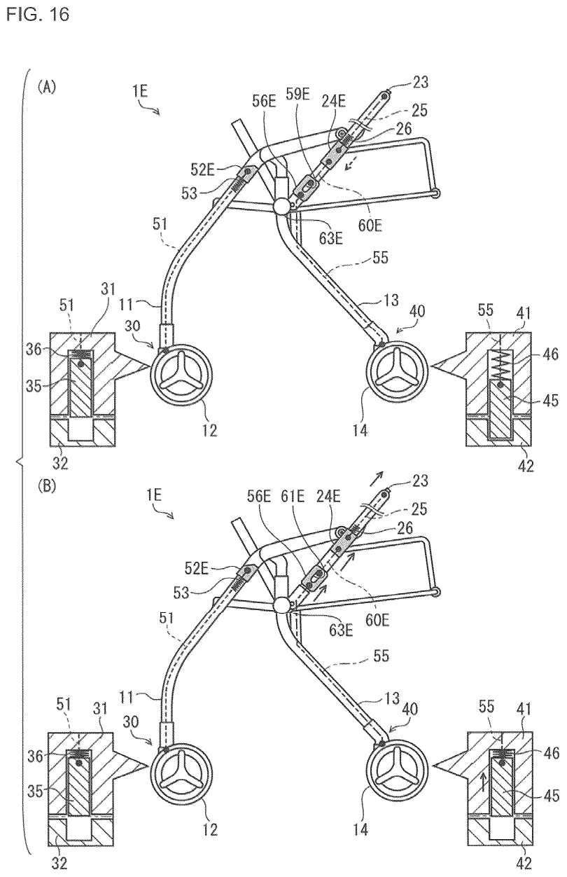

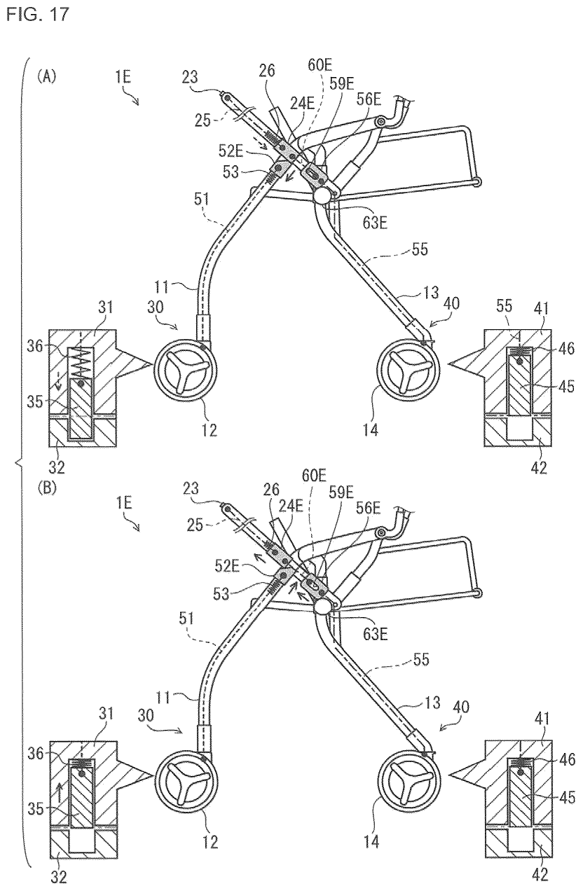

The configuration and operation of a stroller 1E according to a fourth embodiment will be described with reference to FIGS. 16 and 17. The stroller 1E of the present embodiment is basically the same in configuration as the first embodiment. The major difference is that a drive member 24E and a rear-wheel-side displacement member 56E do not contact each other and are connected by an intermediate connecting member 60E. Only the differences from the configuration shown in the first embodiment will be described in detail.

### Configuration

Focusing on the rear wheel 14, in the stroller 1E of the fourth embodiment, the drive member 24E and the rear-wheel-side displacement member 56E are connected by the intermediate connecting member 60E. The rear-wheel-side displacement member 56E of the present embodiment is provided on the push bar 20 rather than on the body frame 10, and is aligned with the drive member 24E in the up-down direction. The rear-wheel-side displacement member 56E is not directly biased in one direction by a biasing member. The rear-wheel-side displacement member 56E has a displacement-member elongated hole 59E at its upper end. Since the displacement-member elongated hole 59E is provided, the intermediate connecting member 60E connects the drive member 24E and the rear-wheel-side displacement member 56E in such a manner that the intermediate connecting member 60E can move up and down within the displacement-member elongated hole 59E of the rear-wheel-side displacement member 56E. Like the rear-wheel connecting member 55 and the operation connecting member 25, the intermediate connecting member 60E is a bendable elongate metal member such as a wire.

The rear leg 13 is provided with a cam 63E that protrudes outward in the width direction of the stroller 1E (toward the push bar 20). The cam 63E has, for example, a circular shape when viewed from the side. The cam 63E is a member that displaces the position of the rear-wheel-side displacement member 56E in the up-down direction. The movement of the rear-wheel-side displacement member 56E caused by the cam 63E will be described later.

### Operation

The operation of restricting or permitting pivoting of the caster mechanisms 30, 40 of the stroller 1E of the present embodiment will be described with reference to FIGS. 16 and 17. FIGS. 16(A) and 16(B) show the push bar 20 in the front-facing position. Specifically, FIG. 16(A) shows a state in which the operation mechanism 22 is not operated, and FIG. 16(B) shows a state in which the operation mechanism 22 is operated. FIGS. 17(A) and 17(B) show the push bar 20 is the rear-facing position. Specifically, FIG. 17(A) shows a state in which the operation mechanism 22 is not operated, and FIG. 17(B) shows a state in which the operation mechanism 22 is operated.

First, the operation when the push bar 20 is in the front-facing position will be described with reference to FIGS. 16(A) and 16(B). As shown in FIG. 16(A), when the push bar 20 is in the front-facing position, the front-wheel caster mechanism 30 is allowed to pivot around its pivot axis, and the rear-wheel caster mechanism 40 is not allowed to pivot around its pivot axis. Specifically, since a front-wheel-side displacement member 52E is biased upward, the front-wheel connecting member 51 is pulled up. Therefore, in the front-wheel caster mechanism 30, the front-wheel caster lock member 35 is located in the unlock position (upper position).

As shown in FIG. 16(B), the operation member 23 is operated to pull up the operation connecting member 25. The drive member 24E is thus moved upward against the biasing force of the second biasing member 26. Since the lower end of the intermediate connecting member 60E is located at the upper end of the displacement-member elongated hole 59E of the rear-wheel-side displacement member 56E, the rear-wheel-side displacement member 56E is also moved upward. The rear-wheel caster lock member 45 can thus be moved to the unlock position (upper position).

Next, the operation when the push bar 20 is in the rear-facing position will be described with reference to FIGS. 17(A) and 17(B). As shown in FIG. 17(A), when the push bar 20 is in the rear-facing position, the rear-wheel caster mechanism 40 is allowed to pivot around its pivot axis, and the front-wheel caster mechanism 30 is not allowed to pivot around its pivot axis.

Specifically, when the push bar 20 is slid from the front-facing position to the rear-facing position, the rear-wheel-side displacement member 56E comes into contact with the cam 63E attached to the rear leg 13 and moves upward. As a result, the rear leg caster lock member 45 is moved against the biasing force of the third biasing member 46. Therefore, the rear-wheel caster lock member 45 is pulled up to the unlock position (upper position) by the rear-wheel connecting member 55. The lower end of the intermediate connecting member 60E is located at the lower end of the displacement-member elongated hole 59E of the rear-wheel-side displacement member 56E. As shown in FIG. 17(A), the front-wheel-side displacement member 52E contacts the drive member 24E provided on the push bar 20 displaced to the rear-facing position, and moves downward, namely in such a direction that the front-wheel-side displacement member 52E feeds out the front-wheel connecting member 51. The front-wheel-side displacement member 52E thus feeds out the front-wheel connecting member 51. As a result, the front-wheel caster lock member 35 is moved to the lock position (lower position) by the biasing force of the front-wheel third biasing member 36.

As shown in FIG. 17(B), the operation member 23 is operated to pull up the operation connecting member 25. The drive member 24E is thus moved upward against the biasing force of the second biasing member 26. The front-wheel-side displacement member 52E that has been in contact with the drive member 24E is moved upward by the biasing force of the front-wheel-side first biasing member 53E. As a result, the front-wheel caster lock member 35 is moved to the unlock position (upper position). As shown in FIG. 17(A), before this operation, the lower end of the intermediate connecting member 60E is located at the lower end of the displacement-member elongated hole 59E. Therefore, as shown in FIG. 17(B), even when the operation member 23 is operated to pull up the operation connecting member 25 and thus pull up the intermediate connecting member 60E, the position of the rear-wheel-side displacement member 56E does not change.

### Fifth Embodiment

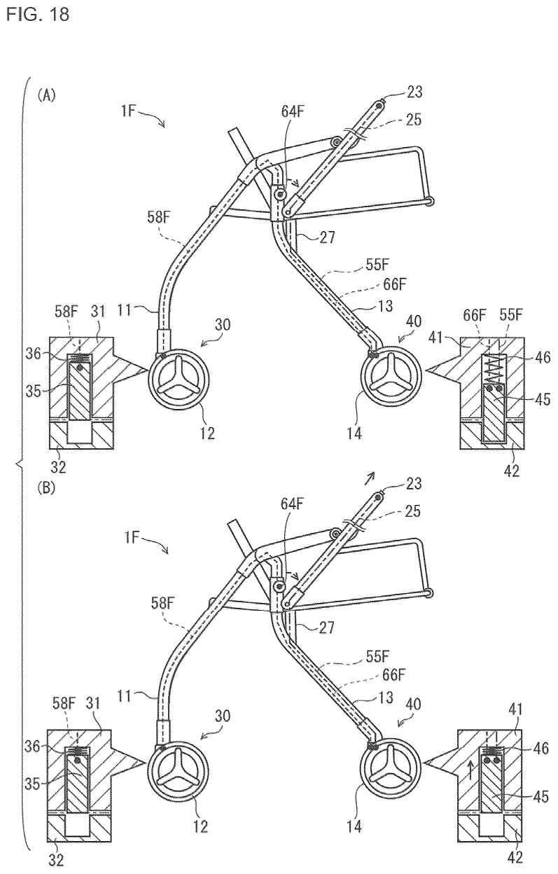

The configuration and operation of a stroller 1F according to a fifth embodiment will be described with reference to FIGS. 18 to 20. The stroller 1F of the present embodiment is basically the same in configuration as the third embodiment. The major differences are that the front-wheel-side displacement member and the wheel connecting members are not provided and that connecting members 58F, 66F are connected to an inter-wheel displacement member 64F. Only the differences from the configuration shown in the third embodiment will be described in detail.

### Configurations

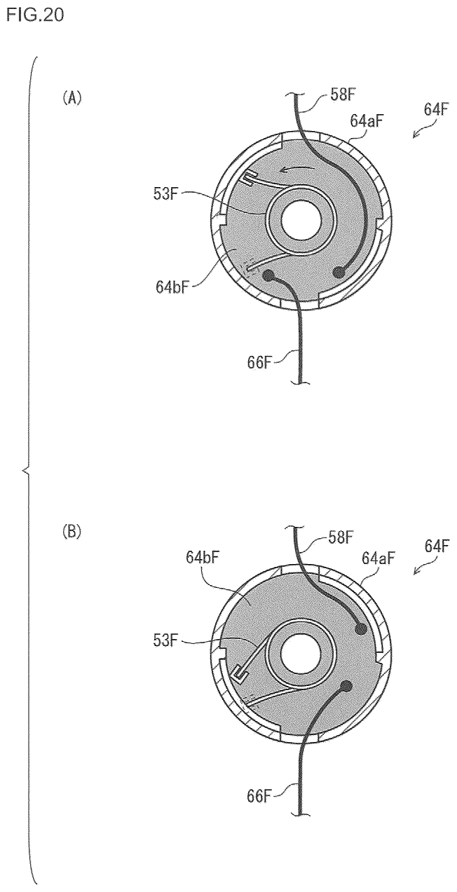

The inter-wheel displacement member 64F is configured such that its length can be changed by itself. The inter-wheel displacement member 64F is pivotable relative to the rear leg 13. As shown in FIG. 20(A), the inter-wheel displacement member 64F includes a case 64aF attached to the rear leg 13 and a rotating body 64bF that rotates on its own axis relative to the case 64aF. The rotating body 64bF is shown shaded in FIG. 20. The front-wheel connecting member 58F and the second rear-wheel connecting member 66F are fixed in an offset manner to the rotating body 64bF. The rotating body 64bF is rotated clockwise by a front-wheel-side first biasing member 53F to wind up the front-wheel connecting member 58F and feed out the second rear-wheel connecting member 66F. The front-wheel-side first biasing member 53F is, for example, a spring, and a torsion spring is shown in FIG. 20. The front-wheel-side first biasing member 53F is provided between the case 64aF and the rotating body 64bF. One end of the front-wheel-side first biasing member 53F is fixed to the rotating body 64bF, and the other end of the front-wheel-side first biasing member 53F is fixed to the case 64aF.

### Operation

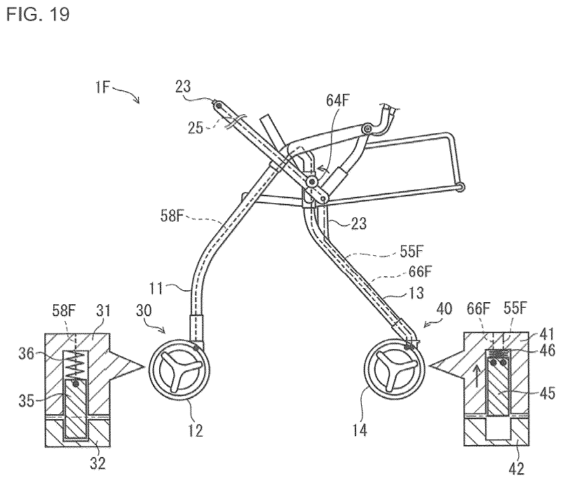

The operation of restricting or permitting pivoting of the caster mechanisms 30, 40 of the stroller 1F of the present embodiment will be described with reference to FIGS. 18 to 20. FIGS. 18(A) and 18(B) show the push bar 20 in the front-facing position. FIG. 18(A) shows a state in which the operation mechanism 22 is not operated, and FIG. 18(B) shows a state in which the operation mechanism 22 is operated. FIG. 19 shows the push bar 20 is the rear-facing position.

First, the operation when the push bar 20 is in the front-facing position will be described with reference to FIGS. 18(A) and 18(B). As shown in FIG. 18(A), when the push bar 20 is in the front-facing position, the front-wheel caster mechanism 30 is allowed to pivot around its pivot axis, and the rear-wheel caster mechanism 40 is not allowed to pivot around its pivot axis. Specifically, the inter-wheel displacement member 64F is biased upward clockwise by the front-wheel-side first biasing member 53F. Namely, the inter-wheel displacement member 52 is biased in such a direction that it winds up the front-wheel connecting member 58F. Therefore, in the front-wheel caster mechanism 30, the front-wheel caster lock member 35 is located in the unlock position (upper position).

As shown in FIG. 18(B), when the operation member 23 is operated to pull up the operation connecting member 25, a first rear-wheel connecting member 55F is moved upward. The rear-wheel caster lock member 45 can thus be moved to the unlock position (upper position).

Next, the operation when the push bar 20 is in the rear-facing position will be described with reference to FIG. 19. As shown in FIG. 19, when the push bar 20 is in the rear-facing position, the rear-wheel caster mechanism 40 is allowed to pivot around its pivot axis, and the front-wheel caster mechanism 30 is not allowed to pivot around its pivot axis.

Specifically, when the push bar 20 is slid from the front-facing position to the rear-facing position, the inter-wheel displacement member 64F biased clockwise by the front-wheel-side first biasing member 53F comes into contact with the push bar 20 displaced in the rear-facing position. As a result, as shown in FIGS. 19 and 20(B), the inter-wheel displacement member 64F is rotated counterclockwise, namely in such a direction that the inter-wheel displacement member 64F feeds out the front-wheel connecting member 58F. The rotating body 64bF is rotated against the biasing force of the front-wheel third biasing member 36. The inter-wheel displacement member 64F thus feeds out the front-wheel connecting member 58F and winds up the second rear-wheel connecting member 66F. As described above, by swinging the push bar 20, the front-wheel caster lock member 35 is moved to the lock position (lower position), and the rear-wheel caster lock member 45 is moved to the unlock position (upper position).

### Modifications of Embodiments

In all of the embodiments except the modifications of the second embodiment, all of the front wheels 12 and the rear wheels 14 are caster wheels. However, it is sufficient if at least one of the four wheels is a caster wheel, and the remaining three wheels may be ordinary wheels that do not pivot around a vertical axis. Alternatively, at least the pair of front wheels 12 or the pair of rear wheels 14 may be caster wheels.

In all of the embodiments except the modifications of the second embodiment, the push bar 20 is slidable between the front-facing position and the rear-facing position via the swing shafts 21. However, the push bar 20 need not necessarily be slidable. For example, the push bar 20 may be detachable from the body frame 10, and may be detached from the body frame 10 and reattached thereto when switching the push bar 20 between the front-facing position and the rear-facing position. That is, the push bar 20 may be of any type as long as the push bar 20 is switchable between the front-facing position and the rear-facing position, and how to perform switching is not particularly limited.

In the above embodiments, the first biasing member that biases the wheel caster lock member toward the lock position and the second biasing member that biases the operation member toward the first position (upper position) are provided. However, these biasing members need not necessarily be provided in a brake mechanism, and whether to provide these biasing members is determined according to the required precision of the brake mechanism.

In the above embodiments, the front-wheel caster lock member 35 is provided in the front-wheel caster holding member 31, and the rear-wheel caster lock member 45 is provided in the rear-wheel caster holding member 41. However, the wheel caster lock member may be provided in the front-wheel caster pivot member 32 or the rear-wheel caster pivot member 42. The wheel caster lock member may be provided at any position as long as it is provided in the front-wheel caster member 30 or the rear-wheel caster member 40.

In the above embodiments, the third biasing members 36, 46 that respectively bias the caster lock members 35, 45 toward the lock position are provided. However, the third biasing members 36, 46 are provided to stabilize the operation of the caster lock members 35, 45, and may not be provided.

The drive members 24, 24D, and 24E of the first to fourth embodiments are operable by the operation member 23 of the operation mechanism 22 and form part of the operation mechanism 22. However, the drive members 24, 24D, and 24E may be provided as separate members. For example, the drive members 24, 24D, and 24E may be manually operable, or may be provided with a fixing portion etc. for fixing the drive member to the push bar 20 so as to retain the position of the drive member.

Although several embodiments have been described in the present specification, configurations of these embodiments may be extracted and combined as appropriate.

While the embodiments of the present invention have been described above with reference to the drawings, the present invention is not limited to them. Various changes and modifications may be made to the illustrated embodiments without departing from the spirit and scope of the invention.

1. A wheeled childcare device comprising:
a body frame including a front leg, a rear leg, and a push bar that is switchable between a front-facing position and a rear-facing position;
a caster mechanism including a caster holding member and a caster pivot member and configured to allow a front wheel or a rear wheel to swivel, the caster holding member being provided at a lower end of the front leg or the rear leg, the caster pivot member being held by the caster holding member so as to be pivotable around a pivot axis extending in an up-down direction, and the caster pivot member supporting the front wheel or the rear wheel via a shaft;
a caster lock member provided in the caster mechanism and configured to restrict pivoting of the caster pivot member when the caster lock member is in a lock position and to permit the pivoting of the caster pivot member when the caster lock member is in an unlock position;
a displacement member provided on the body frame and connected to the caster lock member via a connecting member, the displacement member being configured to be displaced between a first position and a second position according to switching of a position of the push bar, the first position corresponding to the lock position of the caster lock member, and the second position corresponding to the unlock position of the caster lock member; and
an operation mechanism provided on the push bar and configured to operate the displacement member to switch the displacement member the displacement member from the first position to the second position.

2. The wheeled childcare device according to claim 1, further comprising:
a first biasing member configured to bias the displacement member toward the second position.

3. The wheeled childcare device according to claim 1, wherein
the operation mechanism includes an operation member and a drive member, the drive member being connected to the operation member and configured to be switched between a first state and a second state by an operating force of the operation member,
the drive member is configured to move the displacement member to the first position when the drive member is in the first state, and
the drive member is configured to move the displacement member to the second position when the drive member is in the second state.

4. The wheeled childcare device according to claim 2, wherein
the operation mechanism includes an operation member and a drive member, the drive member being connected to the operation member and configured to be switched between a first state and a second state by an operating force of the operation member,
the drive member is configured to counteract a biasing force of the first biasing member on the displacement member when the drive member is in the first state, and
the drive member is configured to allow the biasing force of the first biasing member on the displacement member to act effectively, when the drive member is in the second state.

5. The wheeled childcare device according to claim 4, wherein
the operation mechanism further includes a second biasing member configured to bias the drive member toward the first state, and
a biasing force of the second biasing member is greater than the biasing force of the first biasing member.

6. The wheeled childcare device according to claim 5, further comprising:
a third biasing member configured to bias the caster lock member toward the lock position, wherein
a biasing force of the third biasing member is smaller than the biasing force of the first biasing member.

7. The wheeled childcare device according to claim 1, wherein
the caster mechanism includes
a front-wheel caster mechanism including a front-wheel caster holding member and a front-wheel caster pivot member and configured to allow the front wheel to swivel, the front-wheel caster holding member being provided at the lower end of the front leg, the front-wheel caster pivot member being held by the front-wheel caster holding member so as to be pivotable around a pivot axis extending in the up-down direction, and the front-wheel caster pivot member supporting the front wheel via the shaft, and
a rear-wheel caster mechanism including a rear-wheel caster holding member and a rear-wheel caster pivot member and configured to allow the rear wheel to swivel, the rear-wheel caster holding member being provided at the lower end of the rear leg, the rear-wheel caster pivot member being held by the rear-wheel caster holding member so as to be pivotable around a pivot axis extending in the up-down direction, and the rear-wheel caster pivot member supporting the rear wheel via the shaft, and
the caster lock member includes
a front-wheel caster lock member provided in the front-wheel caster mechanism and configured to restrict pivoting of the front-wheel caster pivot member when the front-wheel caster lock member is in the lock position and to permit the pivoting of the front-wheel caster pivot member when the front-wheel caster lock member is in the unlock position, and
a rear-wheel caster lock member provided in the rear-wheel caster mechanism and configured to restrict pivoting of the rear-wheel caster pivot member when the rear-wheel caster lock member is in the lock position and to permit the pivoting of the rear-wheel caster pivot member when the rear-wheel caster lock member is in the unlock position.

8. The wheeled childcare device according to claim 7, wherein
the displacement member includes
a front-wheel-side displacement member provided on the front leg and connected to the front-wheel caster lock member, the front-wheel-side displacement member being configured to be displaced between a first position and a second position as the front-wheel-side displacement member is pushed by the push bar according to the switching of the position of the push bar, the first position corresponding to the lock position of the front-wheel caster lock member, and the second position corresponding to the unlock position of the front-wheel caster lock member, and
a rear-wheel-side displacement member provided on the rear leg and connected to the rear-wheel caster lock member, the rear-wheel-side displacement member being configured to be displaced between a first position and a second position as the rear-wheel-side displacement member is pushed by the push bar according to the switching of the position of the push bar, the first position corresponding to the lock position of the rear-wheel caster lock member, and the second position corresponding to the unlock position of the rear-wheel caster lock member.

9. The wheeled childcare device according to claim 1, wherein the displacement member is movable up and down along the body frame.

10. The wheeled childcare device according to claim 1, wherein
the displacement member is pivotable relative to the body frame.
